(19) United States
(12) Patent Application Publication
(10) Pub. No.: US 2017/0293501 A1
(43) Pub. Date: Oct. 12, 2017

(54) METHOD AND SYSTEM THAT EXTENDS A PRIVATE DATA CENTER TO ENCOMPASS INFRASTRUCTURE ALLOCATED FROM A REMOTE CLOUD-COMPUTING FACILITY

(71) Applicant: VMWARE, INC., Palo Alto, CA (US)

(72) Inventors: Prateek Barapatre, Bangalore (IN); Yogesh Bendre, Bangalore (IN); Sagar Joshi, Pune (IN); Preethi Chandur, Bangalore (IN); Shyam Sundar Rao Mankala, Bangalore (IN)

(21) Appl. No.: 15/242,614

(22) Filed: Aug. 22, 2016

(30) Foreign Application Priority Data
Apr. 11, 2016 (IN) 201641012617

(51) Int. Cl. G06F 9/455

(52) U.S. Cl. CPC G06F 9/45558; G06F 9/4856

(57) ABSTRACT

The current document is directed to methods and systems that extend cloud-management-facility management from a private data center to infrastructure provided by a remote cloud-computing facility. A remote cloud-management-facility agent is installed within the remote cloud-computing facility to mediate exchange of control and information messages between the cloud-management facility within the private data center and virtual machines executing within the remote cloud-computing facility. The cloud-management-facility agent is connected to the cloud-management facility through a secure tunnel or connection. The cloud-management facility running within the private data center is augmented to include load-discovery functionality and virtual-machine-movement functionality, controlled by policies and parameters specified through an administration-and-management interface to automatically move executing virtual machines back and forth between the private data center and remote cloud-computing facility according to policy-specified goals, considerations, and constraints.

### RELATED APPLICATION

Benefit is claimed under 35 U.S.C. 119(a)-(d) to Foreign Application Serial No. 201641012617 filed in India entitled “METHOD AND SYSTEM THAT EXTENDS A PRIVATE DATA CENTER TO ENCOMPASS INFRASTRUCTURE ALLOCATED FROM A REMOTE CLOUD-COMPUTING FACILITY”, filed on Apr. 11, 2016, by VMware, Inc., which is herein incorporated in its entirety by reference for all purposes.

### TECHNICAL FIELD

The current document is directed to distributed computing systems and, in particular, to extending management of a private data center to infrastructure allocated from a remote cloud-computing facility.

### BACKGROUND

During the past 60 years, computers have evolved from large, slow, and expensive single-processor mainframe computers that provided a tiny fraction of the computational resources of a modern laptop or smart phone to enormous distributed computing systems that include hundreds, thousands, or more networked computer systems, each of which includes multiple processors and gigabytes of memory. The evolution of computer systems has been made possible by rapid increases in the capabilities and capacities of the fundamental components of computer systems, including electronic memories, mass-storage devices, communications subsystems, and processors, as well as the control programs, including operating systems and virtualization layers, that provide robust and reliable control of large numbers of discrete processor-controlled servers, special-purpose data-storage appliances, and other components of modern distributed-computing systems.

Currently, many organizations own, maintain, and administer large private data centers. However, in recent years, a new cloud-computing industry has arisen. Cloud-computing facilities provide infrastructure as a service to remote clients, both individuals and organizations, allowing the clients to contract for computational resources from the cloud-computing facilities on an as-needed basis. Many e-commerce retailers, for example, serve retail websites from virtual data centers instantiated within cloud-computing facilities. Cloud-computing facilities provide computational resources to remote clients much in the same way that public utilities provide electricity and water to their customers.

Private data centers and public cloud-computing facilities provide a variety of different advantages and disadvantages. Private data centers can be made relatively secure, so that application programs running within a private data center of an organization can be maintained relatively securely from eavesdropping, access, or attack by external individuals or organizations. By contrast, when the load on a private data center varies significantly over time, it may be more cost effective to purchase computational bandwidth from a remote cloud-computing facility in order to manage periods of high demand for computing resources rather than expanding the computational resources within a private data center, which are likely to be idle during periods of relatively low computational demand. Currently, system administrators and managers are generally required to decide, in advance, whether to employ a private data center or a remote cloud-computing facility to run particular applications and virtual machines. Although virtual machines and applications can be moved from a private data center to a remote cloud-computing facility, the costs associated with moving virtual machines and/or applications from a private data center to a cloud-computing facility, including manual administration and management interactions, latencies involved in shutting down and restarting applications and virtual machines, and transaction overheads often outweigh the advantages that can be obtained by moving applications and virtual machines from a private data center to a remote cloud-computing facility.

### SUMMARY

The current document is directed to methods and systems that extend cloud-management-facility management from a private data center to infrastructure provided by a remote cloud-computing facility. A remote cloud-management-facility agent is installed within the remote cloud-computing facility to mediate exchange of control and information messages between the cloud-management facility within the private data center and virtual machines executing within the remote cloud-computing facility. The cloud-management-facility agent is connected to the cloud-management facility through a secure tunnel or connection. The cloud-management facility running within the private data center is augmented to include load-discovery functionality and virtual-machine-movement functionality, controlled by policies and parameters specified through an administration-and-management interface to automatically move executing virtual machines back and forth between the private data center and remote cloud-computing facility according to policy-specified goals, considerations, and constraints. In essence, a remote private data center is established within the remote cloud-computing facility so that, during periods of high demand for computational resources within the private data center, execution of virtual machines can be offloaded to the remote private data center automatically, without manual intervention by system administrators and managers.

### BRIEF DESCRIPTION OF THE DRAWINGS

FIG. 1 provides a general architectural diagram for various types of computers.

FIG. 2 illustrates an Internet-connected distributed computer system.

FIG. 3 illustrates cloud computing.

FIG. 4 illustrates generalized hardware and software components of a general-purpose computer system, such as a general-purpose computer system having an architecture similar to that shown in FIG. 1.

FIGS. 5A-B illustrate two types of virtual machine and virtual-machine execution environments.

FIG. 6 illustrates an OVF package.

FIG. 7 illustrates virtual data centers provided as an abstraction of underlying physical-data-center hardware components.

FIG. 8 illustrates virtual-machine components of a VI-management-server and physical servers of a physical data center above which a virtual-data-center interface is provided by the VI-management server.

FIG. 9 illustrates a cloud-director level of abstraction.

FIG. 10 illustrates virtual-cloud-connector nodes (“VCC nodes”) and a VCC server, components of a distributed system that provide multi-cloud aggregation and that include a cloud-connector server and cloud-connector nodes that cooperate to provide services that are distributed across multiple clouds.

FIG. 11 illustrates the VCC server and VCC nodes in a slightly different fashion than the VCC server and VCC nodes illustrated in FIG. 10.

FIG. 13 illustrates electronic communications between a client and server computer.

FIG. 14 illustrates another model for network communications used to interconnect consumers of services with service-providing applications running within server computers.

FIG. 15 illustrates a virtual application.

FIG. 16 illustrates virtualization of networking facilities within a physical data center.

FIG. 17 shows an organization virtual data center in a first cloud-computing facility and an organization virtual data center in a second cloud-computing facility that is used as an example multi-cloud environment in which a VPN is created.

FIGS. 18A-F illustrate an IPsec tunnel.

FIG. 19 shows a workflow-based cloud-management facility that has been developed to provide a powerful administrative and development interface to multiple multi-tenant cloud-computing facilities.

FIG. 20 provides an architectural diagram of the workflow-execution engine and development environment.

FIGS. 21A-C illustrate an example implementation and configuration of virtual appliances within a cloud-computing facility that implement the workflow-based management and administration facilities of the above-described WFMAD.

FIGS. 21D-F illustrate the logical organization of users and user roles with respect to the infrastructure-management-and-administration facility of the WFMAD.

FIG. 22 illustrates the logical components of the infrastructure-management-and-administration facility of the WFMAD.

FIGS. 23A-B illustrate an example computing environment in which the currently disclosed methods and systems can be applied

FIGS. 24A-D provide control-flow diagrams that illustrate one implementation of the local cloud-management-facility agent discussed above with reference to FIG. 23B.

FIG. 25 provides a flow-control diagram that illustrates implementation of the remote cloud-management-facility agent discussed above with reference to FIG. 23B.

FIG. 26 illustrates the type of facility-load, VM-load, and application-load information that may be accessed and compiled by the load-management handler for subsequent application of load policies and candidate-VM-selection policies.

FIG. 27 indicates the nature of load policies that may be specified, maintained, and applied by the load-discovery handler discussed above with reference to FIGS. 24A-B.

### DETAILED DESCRIPTION OF EMBODIMENTS

The current document if directed to extension of cloud-management-facility management to remote infrastructure. In a first subsection, below, an overview of computer hardware and control systems, distributed computer systems, and computer networking is provided. A second subsection describes a cloud-management facility that is used to manage and administer data centers and cloud-computing-facility aggregations. A final subsection discusses the current disclosed methods and systems.

### Overview of Computer Hardware, Operating Systems, Virtualization Layers, and Distributed Computer Systems

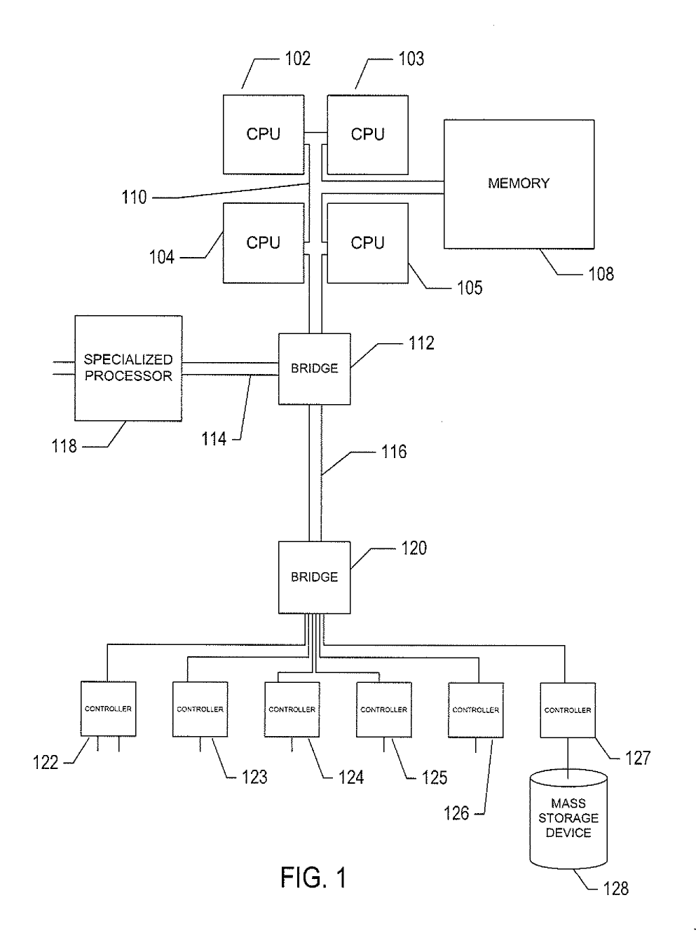

FIG. 1 provides a general architectural diagram for various types of computers. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational resources. It should be noted that computer-readable data-storage devices include optical and electromagnetic disks, electronic memories, and other physical data-storage devices. Those familiar with modern science and technology appreciate that electromagnetic radiation and propagating signals do not store data for subsequent retrieval, and can transiently “store” only a byte or less of information per mile, far less information than needed to encode even the simplest of routines.

Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of servers and workstations, and higher-end mainframe computers, but may also include a plethora of various types of special-purpose computing devices, including data-storage systems, communications routers, network nodes, tablet computers, and mobile telephones.

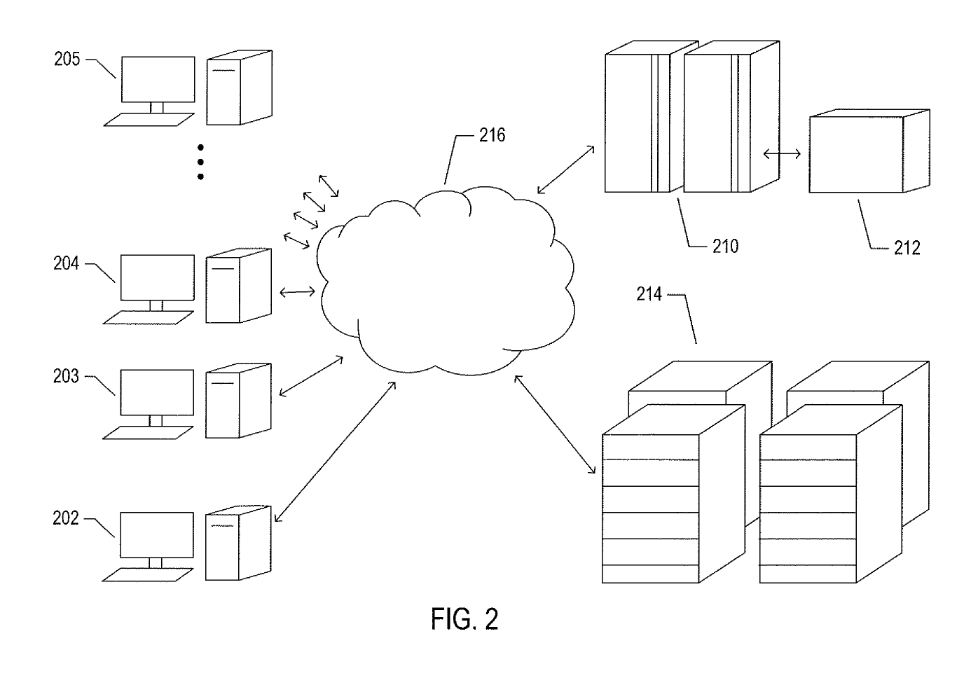

FIG. 2 illustrates an Internet-connected distributed computer system. As communications and networking technologies have evolved in capability and accessibility, and as the computational bandwidths, data-storage capacities, and other capabilities and capacities of various types of computer systems have steadily and rapidly increased, much of modern computing now generally involves large distributed systems and computers interconnected by local networks, wide-area networks, wireless communications, and the Internet. FIG. 2 shows a typical distributed system in which a large number of PCs 202-205, a high-end distributed mainframe system 210 with a large data-storage system 212, and a large computer center 214 with large numbers of rack-mounted servers or blade servers all interconnected through various communications and networking systems that together comprise the Internet 216. Such distributed computer systems provide diverse arrays of functionalities. For example, a PC user sitting in a home office may access hundreds of millions of different web sites provided by hundreds of thousands of different web servers throughout the world and may access high-computational-bandwidth computing services from remote computer facilities for running complex computational tasks.

Until recently, computational services were generally provided by computer systems and data centers purchased, configured, managed, and maintained by service-provider organizations. For example, an e-commerce retailer generally purchased, configured, managed, and maintained a data center including numerous web servers, back-end computer systems, and data-storage systems for serving web pages to remote customers, receiving orders through the web-page interface, processing the orders, tracking completed orders, and other myriad different tasks associated with an e-commerce enterprise.

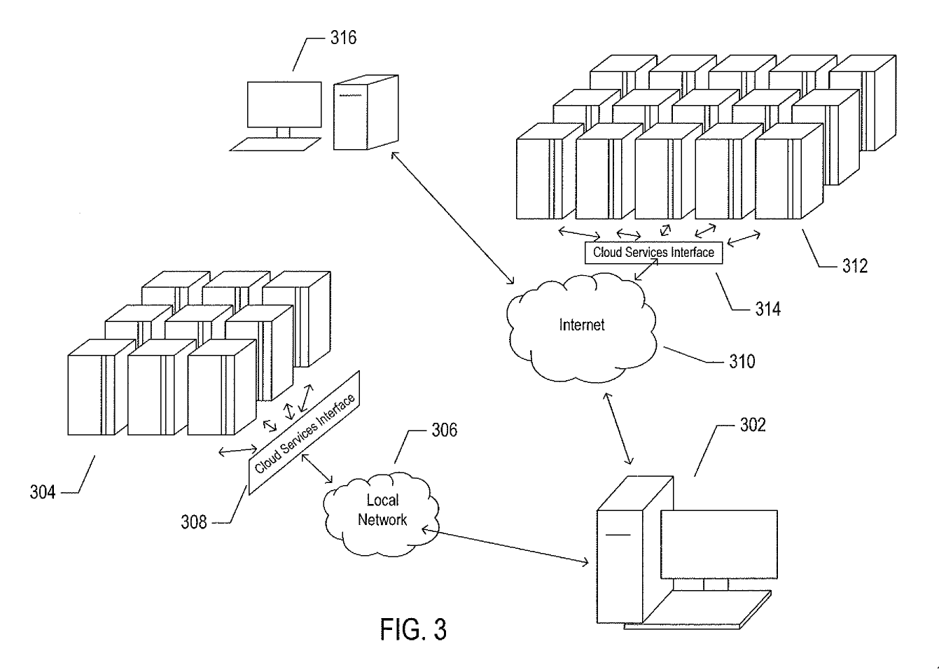

FIG. 3 illustrates cloud computing. In the recently developed cloud-computing paradigm, computing cycles and data-storage facilities are provided to organizations and individuals by cloud-computing providers. In addition, larger organizations may elect to establish private cloud-computing facilities in addition to, or instead of, subscribing to computing services provided by public cloud-computing service providers. In FIG. 3, a system administrator for an organization, using a PC 302, accesses the organization's private cloud 304 through a local network 306 and private-cloud interface 308 and also accesses, through the Internet 310, a public cloud 312 through a public-cloud services interface 314. The administrator can, in either the case of the private cloud 304 or public cloud 312, configure virtual computer systems and even entire virtual data centers and launch execution of application programs on the virtual computer systems and virtual data centers in order to carry out any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 316.

Cloud-computing facilities are intended to provide computational bandwidth and data-storage services much as utility companies provide electrical power and water to consumers. Cloud computing provides enormous advantages to small organizations without the resources to purchase, manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a single organization.

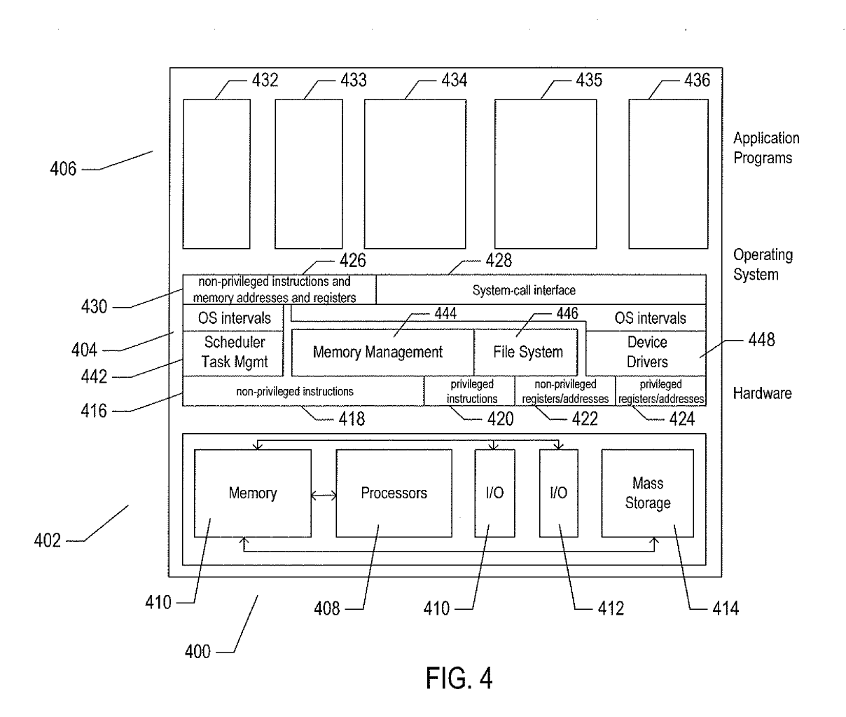

FIG. 4 illustrates generalized hardware and software components of a general-purpose computer system, such as a general-purpose computer system having an architecture similar to that shown in FIG. 1. The computer system 400 is often considered to include three fundamental layers: (1) a hardware layer or level 402; (2) an operating-system layer or level 404; and (3) an application-program layer or level 406. The hardware layer 402 includes one or more processors 408, system memory 410, various different types of input-output (“I/O”) devices 410 and 412, and mass-storage devices 414. Of course, the hardware level also includes many other components, including power supplies, internal communications links and busses, specialized integrated circuits, many different types of processor-controlled or microprocessor-controlled peripheral devices and controllers, and many other components. The operating system 404 interfaces to the hardware level 402 through a low-level operating system and hardware interface 416 generally comprising a set of non-privileged computer instructions 418, a set of privileged computer instructions 420, a set of non-privileged registers and memory addresses 422, and a set of privileged registers and memory addresses 424. In general, the operating system exposes non-privileged instructions, non-privileged registers, and non-privileged memory addresses 426 and a system-call interface 428 as an operating-system interface 430 to application programs 432-436 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 442, memory management 444, a file system 446, device drivers 448, and many other components and modules. To a certain degree, modern operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of various different application programs and higher-level computational entities, providing to each application program a virtual, stand-alone system devoted entirely to the application program. From the application program's standpoint, the application program executes continuously without concern for the need to share processor resources and other system resources with other application programs and higher-level computational entities. The device drivers abstract details of hardware-component operation, allowing application programs to employ the system-call interface for transmitting and receiving data to and from communications networks, mass-storage devices, and other I/O devices and subsystems. The file system 436 facilitates abstraction of mass-storage-device and memory resources as a high-level, easy-to-access, file-system interface. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within various different types of computer hardware. In many cases, popular application programs and computational systems are developed to run on only a subset of the available operating systems, and can therefore be executed within only a subset of the various different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computer system for high-availability, fault-tolerance, and load-balancing purposes. The problems are even greater in heterogeneous distributed computer systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

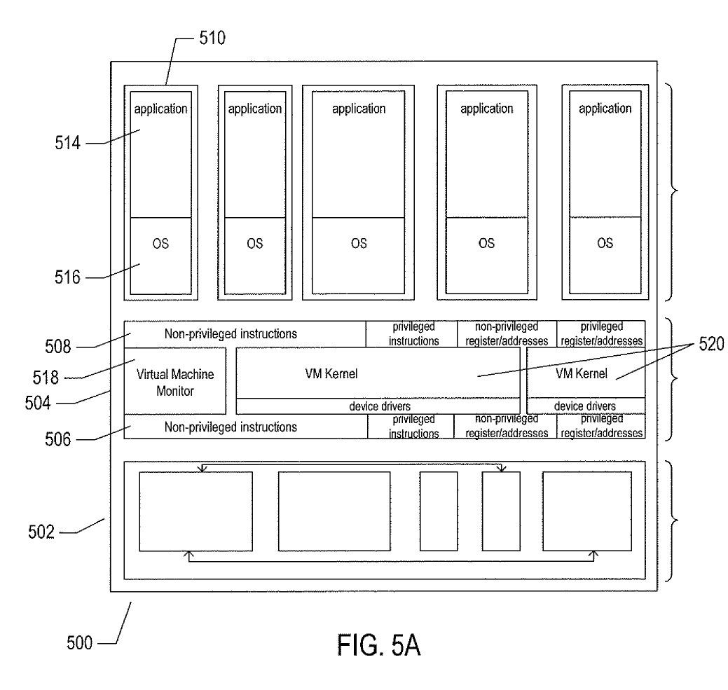

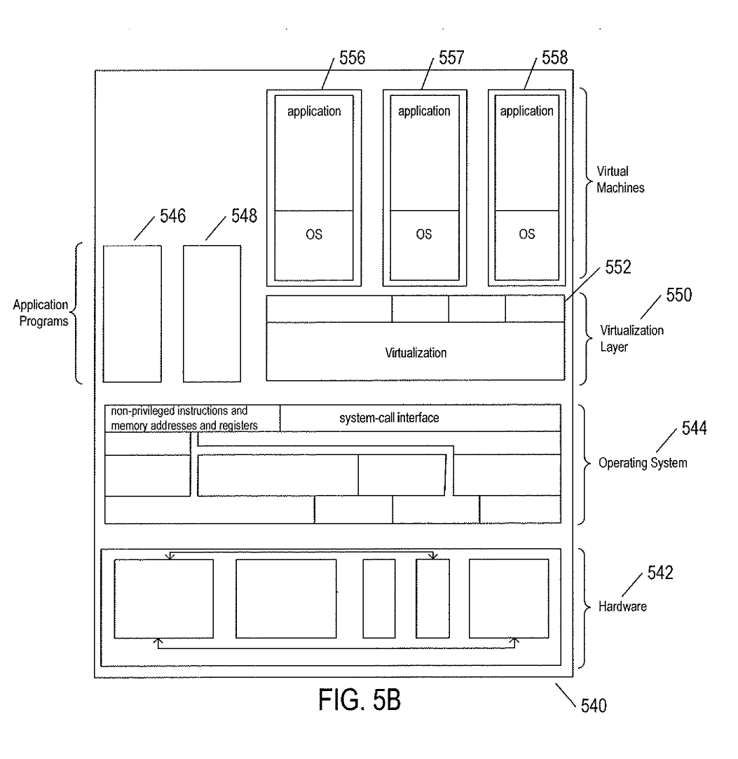

For all of these reasons, a higher level of abstraction, referred to as the “virtual machine,” has been developed and evolved to further abstract computer hardware in order to address many difficulties and challenges associated with traditional computing systems, including the compatibility issues discussed above. FIGS. 5A-B illustrate two types of virtual machine and virtual-machine execution environments. FIGS. 5A-B use the same illustration conventions as used in FIG. 4. FIG. 5A shows a first type of virtualization. The computer system 500 in FIG. 5A includes the same hardware layer 502 as the hardware layer 402 shown in FIG. 4. However, rather than providing an operating system layer directly above the hardware layer, as in FIG. 4, the virtualized computing environment illustrated in FIG. 5A features a virtualization layer 504 that interfaces through a virtualization-layer/hardware-layer interface 506, equivalent to interface 416 in FIG. 4, to the hardware. The virtualization layer provides a hardware-like interface 508 to a number of virtual machines, such as virtual machine 510, executing above the virtualization layer in a virtual-machine layer 512. Each virtual machine includes one or more application programs or other higher-level computational entities packaged together with an operating system, referred to as a “guest operating system,” such as application 514 and guest operating system 516 packaged together within virtual machine 510. Each virtual machine is thus equivalent to the operating-system layer 404 and application-program layer 406 in the general-purpose computer system shown in FIG. 4. Each guest operating system within a virtual machine interfaces to the virtualization-layer interface 508 rather than to the actual hardware interface 506. The virtualization layer partitions hardware resources into abstract virtual-hardware layers to which each guest operating system within a virtual machine interfaces. The guest operating systems within the virtual machines, in general, are unaware of the virtualization layer and operate as if they were directly accessing a true hardware interface. The virtualization layer ensures that each of the virtual machines currently executing within the virtual environment receive a fair allocation of underlying hardware resources and that all virtual machines receive sufficient resources to progress in execution. The virtualization-layer interface 508 may differ for different guest operating systems. For example, the virtualization layer is generally able to provide virtual hardware interfaces for a variety of different types of computer hardware. This allows, as one example, a virtual machine that includes a guest operating system designed for a particular computer architecture to run on hardware of a different architecture. The number of virtual machines need not be equal to the number of physical processors or even a multiple of the number of processors.

The virtualization layer includes a virtual-machine-monitor module 518 (“VMM”) that virtualizes physical processors in the hardware layer to create virtual processors on which each of the virtual machines executes. For execution efficiency, the virtualization layer attempts to allow virtual machines to directly execute non-privileged instructions and to directly access non-privileged registers and memory. However, when the guest operating system within a virtual machine accesses virtual privileged instructions, virtual privileged registers, and virtual privileged memory through the virtualization-layer interface 508, the accesses result in execution of virtualization-layer code to simulate or emulate the privileged resources. The virtualization layer additionally includes a kernel module 520 that manages memory, communications, and data-storage machine resources on behalf of executing virtual machines (“VM kernel”). The VM kernel, for example, maintains shadow page tables on each virtual machine so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtualization layer essentially schedules execution of virtual machines much like an operating system schedules execution of application programs, so that the virtual machines each execute within a complete and fully functional virtual hardware layer.

FIG. 5B illustrates a second type of virtualization. In FIG. 5B, the computer system 540 includes the same hardware layer 542 and software layer 544 as the hardware layer 402 shown in FIG. 4. Several application programs 546 and 548 are shown running in the execution environment provided by the operating system. In addition, a virtualization layer 550 is also provided, in computer 540, but, unlike the virtualization layer 504 discussed with reference to FIG. 5, virtualization layer 550 is layered above the operating system 544, referred to as the “host OS,” and uses the operating system interface to access operating-system-provided functionality as well as the hardware. The virtualization layer 550 comprises primarily a VMM and a hardware-like interface 552, similar to hardware-like interface 508 in FIG. 5A. The virtualization-layer/hardware-layer interface 552, equivalent to interface 416 in FIG. 4, provides an execution environment for a number of virtual machines 556-558, each including one or more application programs or other higher-level computational entities packaged together with a guest operating system.

In FIGS. 5A-B, the layers are somewhat simplified for clarity of illustration. For example, portions of the virtualization layer 550 may reside within the host-operating-system kernel, such as a specialized driver incorporated into the host operating system to facilitate hardware access by the virtualization layer.

It should be noted that virtual hardware layers, virtualization layers, and guest operating systems are all physical entities that are implemented by computer instructions stored in physical data-storage devices, including electronic memories, mass-storage devices, optical disks, magnetic disks, and other such devices. The term “virtual” does not, in any way, imply that virtual hardware layers, virtualization layers, and guest operating systems are abstract or intangible. Virtual hardware layers, virtualization layers, and guest operating systems execute on physical processors of physical computer systems and control operation of the physical computer systems, including operations that alter the physical states of physical devices, including electronic memories and mass-storage devices. They are as physical and tangible as any other component of a computer since, such as power supplies, controllers, processors, busses, and data-storage devices.

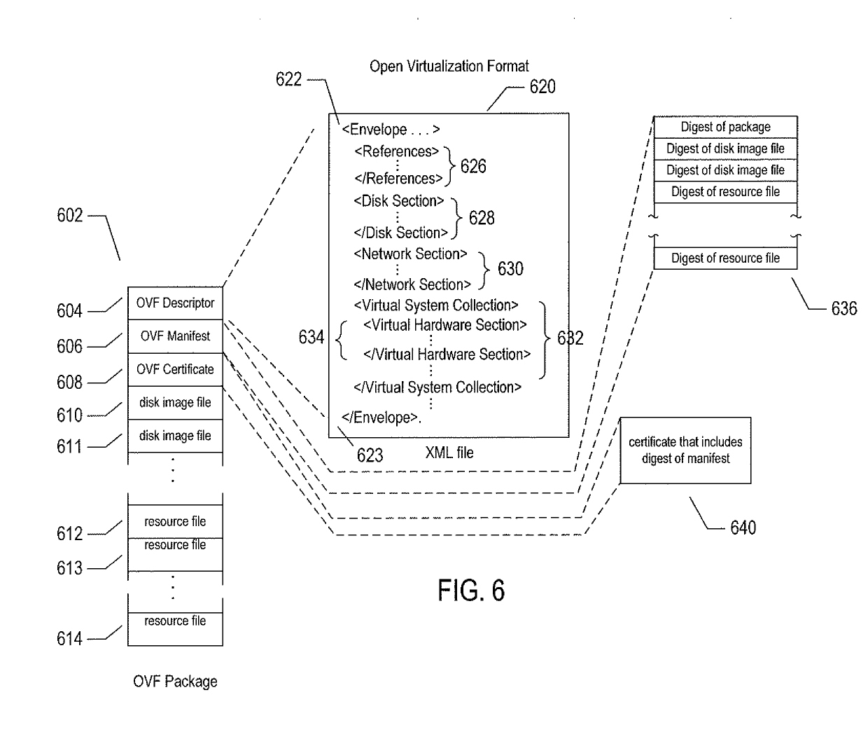

A virtual machine or virtual application, described below, is encapsulated within a data package for transmission, distribution, and loading into a virtual-execution environment. One public standard for virtual-machine encapsulation is referred to as the “open virtualization format” (“OVF”). The OVF standard specifies a format for digitally encoding a virtual machine within one or more data files. FIG. 6 illustrates an OVF package. An OVF package 602 includes an OVF descriptor 604, an OVF manifest 606, an OVF certificate 608, one or more disk-image files 610-611, and one or more resource files 612-614. The OVF package can be encoded and stored as a single file or as a set of files. The OVF descriptor 604 is an XML document 620 that includes a hierarchical set of elements, each demarcated by a beginning tag and an ending tag. The outermost, or highest-level, element is the envelope element, demarcated by tags 622 and 623. The next-level element includes a reference element 626 that includes references to all files that are part of the OVF package, a disk section 628 that contains meta information about all of the virtual disks included in the OVF package, a networks section 630 that includes meta information about all of the logical networks included in the OVF package, and a collection of virtual-machine configurations 632 which further includes hardware descriptions of each virtual machine 634. There are many additional hierarchical levels and elements within a typical OVF descriptor. The OVF descriptor is thus a self-describing XML file that describes the contents of an OVF package. The OVF manifest 606 is a list of cryptographic-hash-function-generated digests 636 of the entire OVF package and of the various components of the OVF package. The OVF certificate 608 is an authentication certificate 640 that includes a digest of the manifest and that is cryptographically signed. Disk image files, such as disk image file 610, are digital encodings of the contents of virtual disks and resource files 612 are digitally encoded content, such as operating-system images. A virtual machine or a collection of virtual machines encapsulated together within a virtual application can thus be digitally encoded as one or more files within an OVF package that can be transmitted, distributed, and loaded using well-known tools for transmitting, distributing, and loading files. A virtual appliance is a software service that is delivered as a complete software stack installed within one or more virtual machines that is encoded within an OVF package.

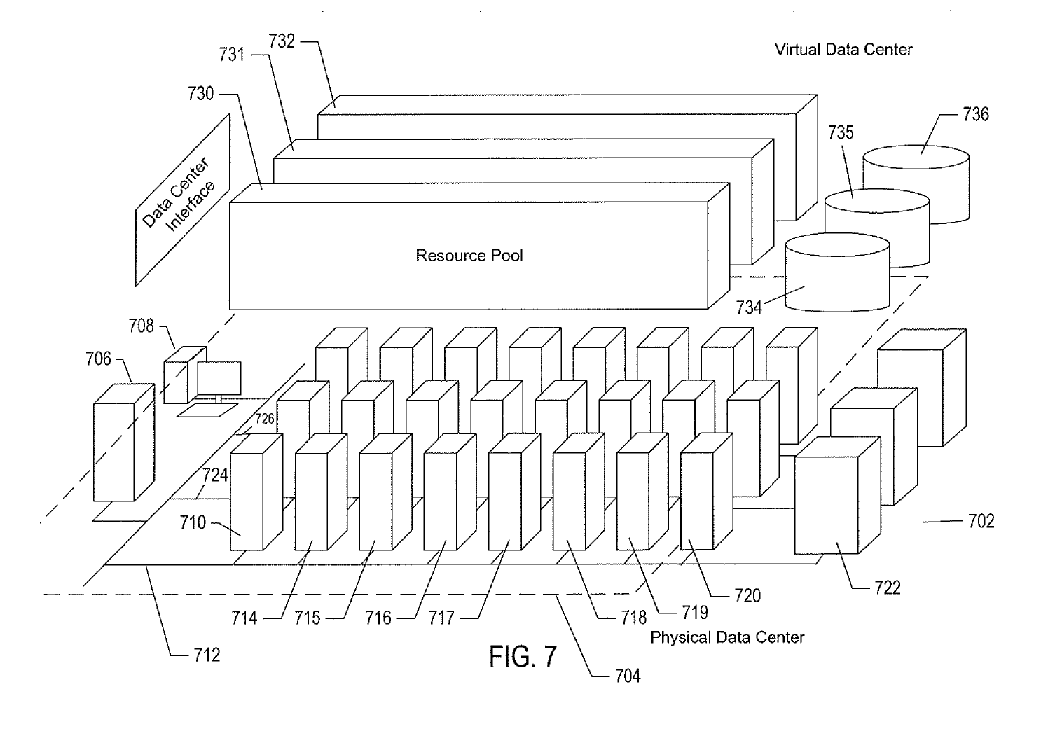

The advent of virtual machines and virtual environments has alleviated many of the difficulties and challenges associated with traditional general-purpose computing. Machine and operating-system dependencies can be significantly reduced or entirely eliminated by packaging applications and operating systems together as virtual machines and virtual appliances that execute within virtual environments provided by virtualization layers running on many different types of computer hardware. A next level of abstraction, referred to as virtual data centers which are one example of a broader virtual-infrastructure category, provide a data-center interface to virtual data centers computationally constructed within physical data centers. FIG. 7 illustrates virtual data centers provided as an abstraction of underlying physical-data-center hardware components. In FIG. 7, a physical data center 702 is shown below a virtual-interface plane 704. The physical data center consists of a virtual-infrastructure management server (“VI-management-server”) 706 and any of various different computers, such as PCs 708, on which a virtual-data-center management interface may be displayed to system administrators and other users. The physical data center additionally includes generally large numbers of server computers, such as server computer 710, that are coupled together by local area networks, such as local area network 712 that directly interconnects server computer 710 and 714-720 and a mass-storage array 722. The physical data center shown in FIG. 7 includes three local area networks 712, 724, and 726 that each directly interconnects a bank of eight servers and a mass-storage array. The individual server computers, such as server computer 710, each includes a virtualization layer and runs multiple virtual machines. Different physical data centers may include many different types of computers, networks, data-storage systems and devices connected according to many different types of connection topologies. The virtual-data-center abstraction layer 704, a logical abstraction layer shown by a plane in FIG. 7, abstracts the physical data center to a virtual data center comprising one or more resource pools, such as resource pools 730-732, one or more virtual data stores, such as virtual data stores 734-736, and one or more virtual networks. In certain implementations, the resource pools abstract banks of physical servers directly interconnected by a local area network.

The virtual-data-center management interface allows provisioning and launching of virtual machines with respect to resource pools, virtual data stores, and virtual networks, so that virtual-data-center administrators need not be concerned with the identities of physical-data-center components used to execute particular virtual machines. Furthermore, the VI-management-server includes functionality to migrate running virtual machines from one physical server to another in order to optimally or near optimally manage resource allocation, provide fault tolerance, and high availability by migrating virtual machines to most effectively utilize underlying physical hardware resources, to replace virtual machines disabled by physical hardware problems and failures, and to ensure that multiple virtual machines supporting a high-availability virtual appliance are executing on multiple physical computer systems so that the services provided by the virtual appliance are continuously accessible, even when one of the multiple virtual appliances becomes compute bound, data-access bound, suspends execution, or fails. Thus, the virtual data center layer of abstraction provides a virtual-data-center abstraction of physical data centers to simplify provisioning, launching, and maintenance of virtual machines and virtual appliances as well as to provide high-level, distributed functionalities that involve pooling the resources of individual physical servers and migrating virtual machines among physical servers to achieve load balancing, fault tolerance, and high availability.

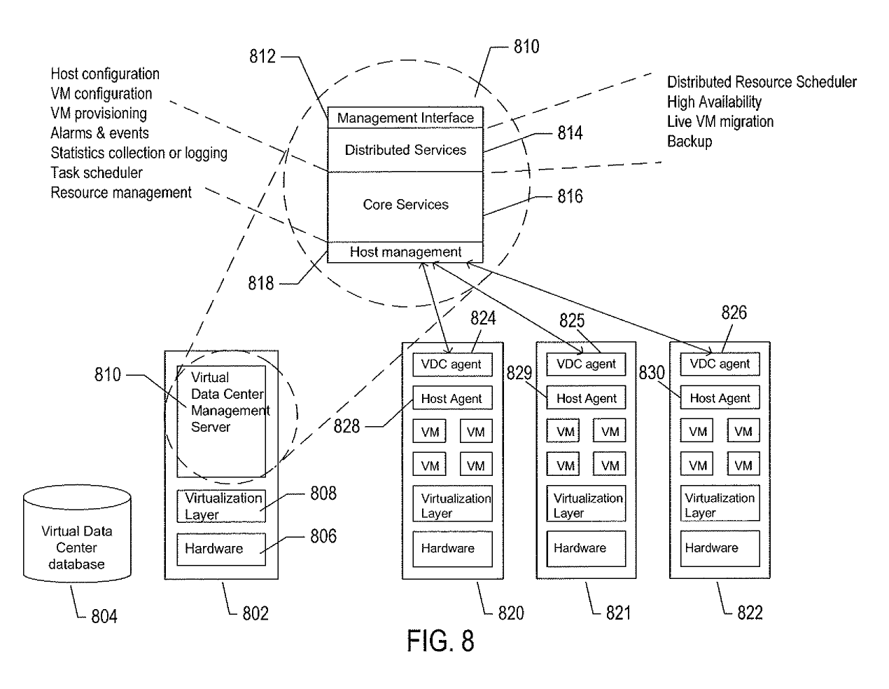

FIG. 8 illustrates virtual-machine components of a VI-management-server and physical servers of a physical data center above which a virtual-data-center interface is provided by the VI-management-server. The VI-management-server 802 and a virtual-data-center database 804 comprise the physical components of the management component of the virtual data center. The VI-management-server 802 includes a hardware layer 806 and virtualization layer 808, and runs a virtual-data-center management-server virtual machine 810 above the virtualization layer. Although shown as a single server in FIG. 8, the VI-management-server (“VI management server”) may include two or more physical server computers that support multiple VI-management-server virtual appliances. The virtual machine 810 includes a management-interface component 812, distributed services 814, core services 816, and a host-management interface 818. The management interface is accessed from any of various computers, such as the PC 708 shown in FIG. 7. The management interface allows the virtual-data-center administrator to configure a virtual data center, provision virtual machines, collect statistics and view log files for the virtual data center, and to carry out other, similar management tasks. The host-management interface 818 interfaces to virtual-data-center agents 824, 825, and 826 that execute as virtual machines within each of the physical servers of the physical data center that is abstracted to a virtual data center by the VI management server.

The distributed services 814 include a distributed-resource scheduler that assigns virtual machines to execute within particular physical servers and that migrates virtual machines in order to most effectively make use of computational bandwidths, data-storage capacities, and network capacities of the physical data center. The distributed services further include a high-availability service that replicates and migrates virtual machines in order to ensure that virtual machines continue to execute despite problems and failures experienced by physical hardware components. The distributed services also include a live-virtual-machine migration service that temporarily halts execution of a virtual machine, encapsulates the virtual machine in an OVF package, transmits the OVF package to a different physical server, and restarts the virtual machine on the different physical server from a virtual-machine state recorded when execution of the virtual machine was halted. The distributed services also include a distributed backup service that provides centralized virtual-machine backup and restore.

The core services provided by the VI management server include host configuration, virtual-machine configuration, virtual-machine provisioning, generation of virtual-data-center alarms and events, ongoing event logging and statistics collection, a task scheduler, and a resource-management module. Each physical server 820-822 also includes a host-agent virtual machine 828-830 through which the virtualization layer can be accessed via a virtual-infrastructure application programming interface (“API”). This interface allows a remote administrator or user to manage an individual server through the infrastructure API. The virtual-data-center agents 824-826 access virtualization-layer server information through the host agents. The virtual-data-center agents are primarily responsible for offloading certain of the virtual-data-center management-server functions specific to a particular physical server to that physical server. The virtual-data-center agents relay and enforce resource allocations made by the VI management server, relay virtual-machine provisioning and configuration-change commands to host agents, monitor and collect performance statistics, alarms, and events communicated to the virtual-data-center agents by the local host agents through the interface API, and to carry out other, similar virtual-data-management tasks.

The virtual-data-center abstraction provides a convenient and efficient level of abstraction for exposing the computational resources of a cloud-computing facility to cloud-computing-infrastructure users. A cloud-director management server exposes virtual resources of a cloud-computing facility to cloud-computing-infrastructure users. In addition, the cloud director introduces a multi-tenancy layer of abstraction, which partitions virtual data centers (“VDCs”) into tenant-associated VDCs that can each be allocated to a particular individual tenant or tenant organization, both referred to as a “tenant.” A given tenant can be provided one or more tenant-associated VDCs by a cloud director managing the multi-tenancy layer of abstraction within a cloud-computing facility. The cloud services interface (308 in FIG. 3) exposes a virtual-data-center management interface that abstracts the physical data center.

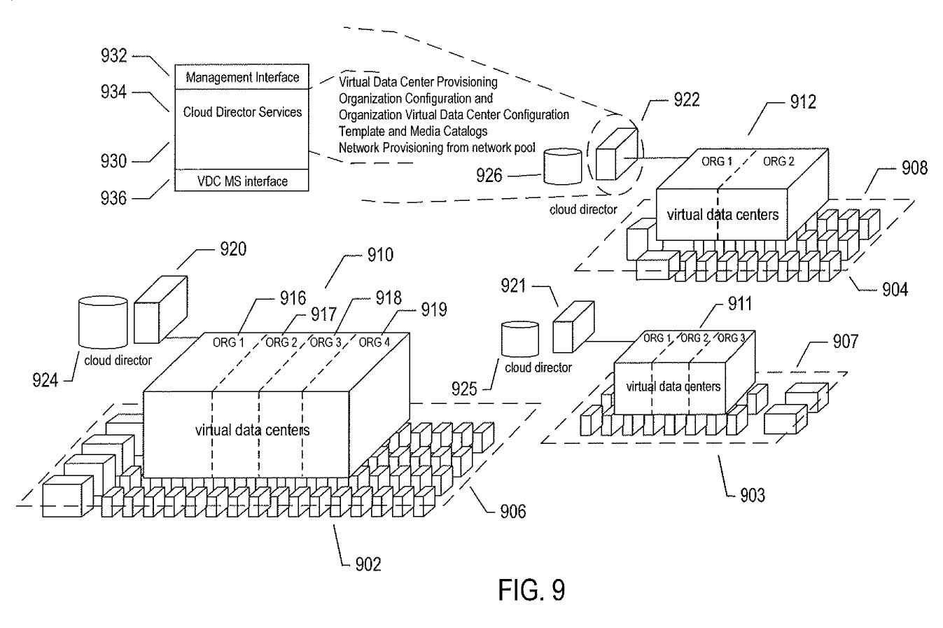

FIG. 9 illustrates a cloud-director level of abstraction. In FIG. 9, three different physical data centers 902-904 are shown below planes representing the cloud-director layer of abstraction 906-908. Above the planes representing the cloud-director level of abstraction, multi-tenant virtual data centers 910-912 are shown. The resources of these multi-tenant virtual data centers are securely partitioned in order to provide secure virtual data centers to multiple tenants, or cloud-services-accessing organizations. For example, a cloud-services-provider virtual data center 910 is partitioned into four different tenant-associated virtual-data centers within a multi-tenant virtual data center for four different tenants 916-919. Each multi-tenant virtual data center is managed by a cloud director comprising one or more cloud-director servers 920-922 and associated cloud-director databases 924-926. Each cloud-director server or servers runs a cloud-director virtual appliance 930 that includes a cloud-director management interface 932, a set of cloud-director services 934, and a virtual-data-center management-server interface 936. The cloud-director services include an interface and tools for provisioning multi-tenant virtual data center virtual data centers on behalf of tenants, tools and interfaces for configuring and managing tenant organizations, tools and services for organization of virtual data centers and tenant-associated virtual data centers within the multi-tenant virtual data center, services associated with template and media catalogs, and provisioning of virtualization networks from a network pool. Templates are virtual machines that each contains an OS and/or one or more virtual machines containing applications. A template may include much of the detailed contents of virtual machines and virtual appliances that are encoded within OVF packages, so that the task of configuring a virtual machine or virtual appliance is significantly simplified, requiring only deployment of one OVF package. These templates are stored in catalogs within a tenant's virtual-data center. These catalogs are used for developing and staging new virtual appliances and published catalogs are used for sharing templates in virtual appliances across organizations. Catalogs may include OS images and other information relevant to construction, distribution, and provisioning of virtual appliances.

Considering FIGS. 7 and 9, the VI management server and cloud-director layers of abstraction can be seen, as discussed above, to facilitate employment of the virtual-data-center concept within private and public clouds. However, this level of abstraction does not fully facilitate aggregation of single-tenant and multi-tenant virtual data centers into heterogeneous or homogeneous aggregations of cloud-computing facilities.

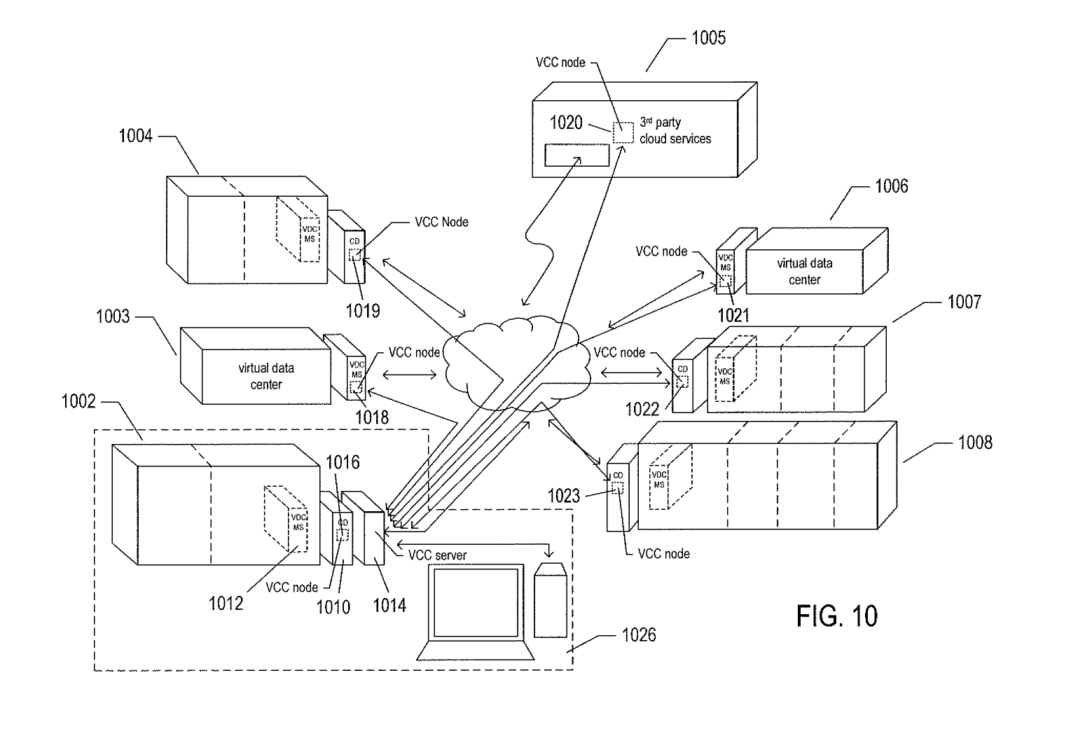

FIG. 10 illustrates virtual-cloud-connector nodes (“VCC nodes”) and a VCC server, components of a distributed system that provides multi-cloud aggregation and that includes a cloud-connector server and cloud-connector nodes that cooperate to provide services that are distributed across multiple clouds. VMware vCloud™ VCC servers and nodes are one example of VCC server and nodes. In FIG. 10, seven different cloud-computing facilities are illustrated 1002-1008. Cloud-computing facility 1002 is a private multi-tenant cloud with a cloud director 1010 that interfaces to a VI management server 1012 to provide a multi-tenant private cloud comprising multiple tenant-associated virtual data centers. The remaining cloud-computing facilities 1003-1008 may be either public or private cloud-computing facilities and may be single-tenant virtual data centers, such as virtual data centers 1003 and 1006, multi-tenant virtual data centers, such as multi-tenant virtual data centers 1004 and 1007-1008, or any of various different kinds of third-party cloud-services facilities, such as third-party cloud-services facility 1005. An additional component, the VCC server 1014, acting as a controller is included in the private cloud-computing facility 1002 and interfaces to a VCC node 1016 that runs as a virtual appliance within the cloud director 1010. A VCC server may also run as a virtual appliance within a VI management server that manages a single-tenant private cloud. The VCC server 1014 additionally interfaces, through the Internet, to VCC node virtual appliances executing within remote VI management servers, remote cloud directors, or within the third-party cloud services 1018-1023. The VCC server provides a VCC server interface that can be displayed on a local or remote terminal, PC, or other computer system 1026 to allow a cloud-aggregation administrator or other user to access VCC-server-provided aggregate-cloud distributed services. In general, the cloud-computing facilities that together form a multiple-cloud-computing aggregation through distributed services provided by the VCC server and VCC nodes are geographically and operationally distinct.

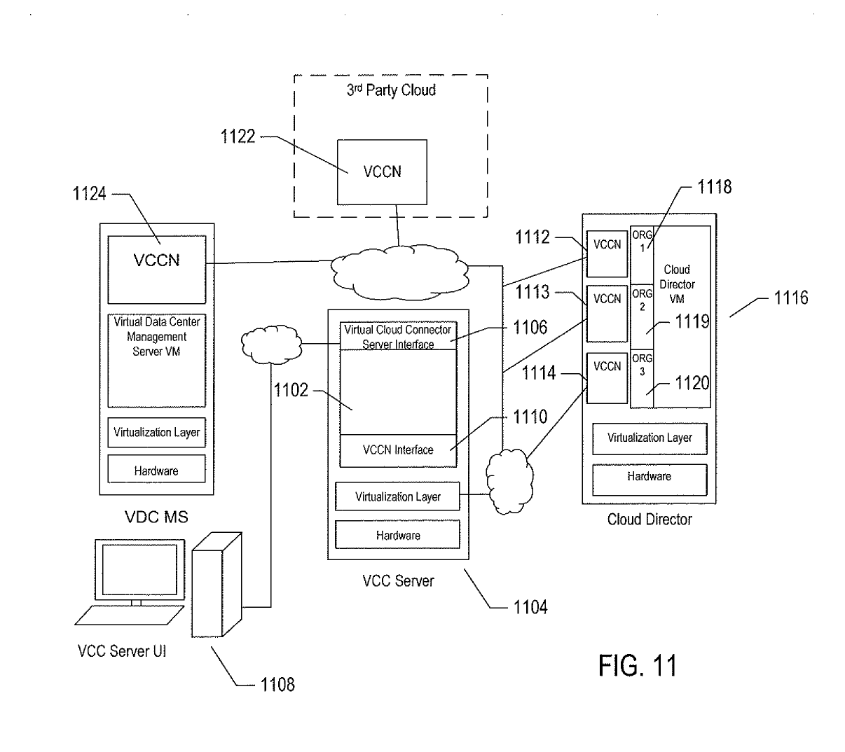

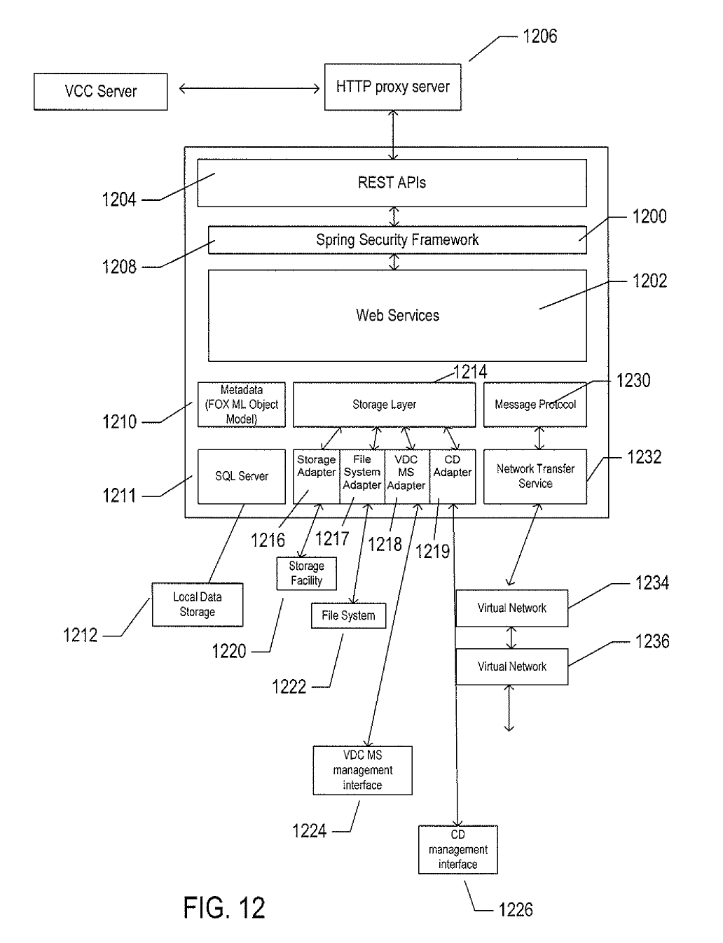

FIG. 11 illustrates the VCC server and VCC nodes in a slightly different fashion than the VCC server and VCC nodes are illustrated in FIG. 10. In FIG. 11, the VCC server virtual machine 1102 is shown executing within a VCC server 1104, one or more physical servers located within a private cloud-computing facility. The VCC-server virtual machine includes a VCC-server interface 1106 through which a terminal, PC, or other computing device 1108 interfaces to the VCC server. The VCC server, upon request, displays a VCC-server user interface on the computing device 1108 to allow a cloud-aggregate administrator or other user to access VCC-server-provided functionality. The VCC-server virtual machine additionally includes a VCC-node interface 1108 through which the VCC server interfaces to VCC-node virtual appliances that execute within VDC management servers, cloud directors, and third-party cloud-computing facilities. As shown in FIG. 11, in one implementation, a VCC-node virtual machine is associated with each organization configured within and supported by a cloud director. Thus, VCC nodes 1112-1114 execute as virtual appliances within cloud director 1116 in association with organizations 1118-1120, respectively. FIG. 11 shows a VCC-node virtual machine 1122 executing within a third-party cloud-computing facility and a VCC-node virtual machine 1124 executing within a VDC management server. The VCC server, including the services provided by the VCC-server virtual machine 1102, in conjunction with the VCC-node virtual machines running within remote VDC management servers, cloud directors, and within third-party cloud-computing facilities, together provide functionality distributed among the cloud-computing-facility components of either heterogeneous or homogeneous cloud-computing aggregates.

FIG. 12 illustrates one implementation of a VCC node. The VCC node 1200 is a web service that executes within an Apache/Tomcat container that runs as a virtual appliance within a cloud director, VDC management server, or third-party cloud-computing server. The VCC node exposes web services 1202 to a remote VCC server via REST APIs accessed through the representational state transfer (“REST”) protocol 1204 via a hypertext transfer protocol (“HTTP”) proxy server 1206. The REST protocol uses HTTP requests to post data and requests for services, read data and receive service-generated responses, and delete data. The web services 1202 comprise a set of internal functions that are called to execute the REST APIs 1204. Authorization services are provided by a spring security layer 1208. The internal functions that implement the web services exposed by the REST APIs employ a metadata/object-store layer implemented using an SQL Server database 1210-1212, a storage layer 1214 with adapters 1216-1219 provides access to data stores 1220, file systems 1222, the virtual-data-center management-server management interface 1224, and the cloud-director management interface 1226. These adapters may additional include adapters to third-party cloud management services, interfaces, and systems. The internal functions that implement the web services may also access a message protocol 1230 and network transfer services 1232 that allow for transfer of OVF packages and other files securely between VCC nodes via virtual networks 1234 that virtualize underlying physical networks 1236. The message protocol 1230 and network transfer services 1232 together provide for secure data transfer, multipart messaging, and checkpoint-restart data transfer that allows failed data transfers to be restarted from most recent checkpoints, rather than having to be entirely retransmitted.

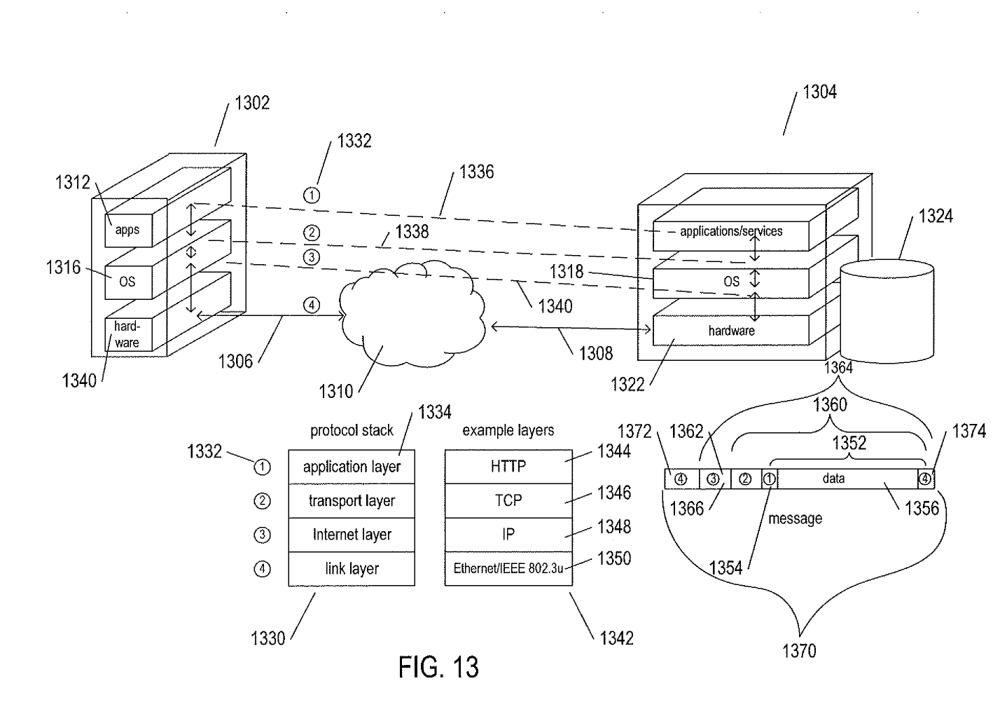

FIG. 13 illustrates electronic communications between a client and server computer. The following discussion of FIG. 13 provides an overview of electronic communications. This is, however, a very large and complex subject area, a full discussion of which would likely run for many hundreds or thousands of pages. The following overview is provided as a basis for discussing communications stacks, with reference to subsequent figures. In FIG. 13, a client computer 1302 is shown to be interconnected with a server computer 1304 via local communication links 1306 and 1308 and a complex distributed intermediary communications system 1310, such as the Internet. This complex communications system may include a large number of individual computer systems and many types of electronic communications media, including wide-area networks, public switched telephone networks, wireless communications, satellite communications, and many other types of electronics-communications systems and intermediate computer systems, routers, bridges, and other device and system components. Both the server and client computers are shown to include three basic internal layers including an applications layer 1312 in the client computer and a corresponding applications and services layer 1314 in the server computer, an operating-system layer 1316 and 1318, and a hardware layer 1320 and 1322. The server computer 1304 is additionally associated with an internal, peripheral, or remote data-storage subsystem 1324. The hardware layers 1320 and 1322 may include the components discussed above with reference to FIG. 1 as well as many additional hardware components and subsystems, such as power supplies, cooling fans, switches, auxiliary processors, and many other mechanical, electrical, electromechanical, and electro-optical-mechanical components. The operating system 1316 and 1318 represents the general control system of both a client computer 1302 and a server computer 1304. The operating system interfaces to the hardware layer through a set of registers that, under processor control, are used for transferring data, including commands and stored information, between the operating system and various hardware components. The operating system also provides a complex execution environment in which various application programs, including database management systems, web browsers, web services, and other application programs execute. In many cases, modern computer systems employ an additional layer between the operating system and the hardware layer, referred to as a “virtualization layer,” that interacts directly with the hardware and provides a virtual-hardware-execution environment for one or more operating systems.

Client systems may include any of many types of processor-controlled devices, including tablet computers, laptop computers, mobile smart phones, and other such processor-controlled devices. These various types of clients may include only a subset of the components included in a desktop personal component as well components not generally included in desktop personal computers.

Electronic communications between computer systems generally comprises packets of information, referred to as datagrams, transferred from client computers to server computers and from server computers to client computers. In many cases, the communications between computer systems is commonly viewed from the relatively high level of an application program which uses an application-layer protocol for information transfer. However, the application-layer protocol is implemented on top of additional layers, including a transport layer, Internet layer, and link layer. These layers are commonly implemented at different levels within computer systems. Each layer is associated with a protocol for data transfer between corresponding layers of computer systems. These layers of protocols are commonly referred to as a “protocol stack.” In FIG. 13, a representation of a common protocol stack 1330 is shown below the interconnected server and client computers 1304 and 1302. The layers are associated with layer numbers, such as layer number “1” 1332 associated with the application layer 1334. These same layer numbers are used in the depiction of the interconnection of the client computer 1302 with the server computer 1304, such as layer number “1” 1332 associated with a horizontal dashed line 1336 that represents interconnection of the application layer 1312 of the client computer with the applications/services layer 1314 of the server computer through an application-layer protocol. A dashed line 1336 represents interconnection via the application-layer protocol in FIG. 13, because this interconnection is logical, rather than physical. Dashed-line 1338 represents the logical interconnection of the operating-system layers of the client and server computers via a transport layer. Dashed line 1340 represents the logical interconnection of the operating systems of the two computer systems via an Internet-layer protocol. Finally, links 1306 and 1308 and cloud 1310 together represent the physical communications media and components that physically transfer data from the client computer to the server computer and from the server computer to the client computer. These physical communications components and media transfer data according to a link-layer protocol. In FIG. 13, a second table 1342 is aligned with the table 1330 that illustrates the protocol stack includes example protocols that may be used for each of the different protocol layers. The hypertext transfer protocol (“HTTP”) may be used as the application-layer protocol 1344, the transmission control protocol (“TCP”) 1346 may be used as the transport-layer protocol, the Internet protocol 1348 (“IP”) may be used as the Internet-layer protocol, and, in the case of a computer system interconnected through a local Ethernet to the Internet, the Ethernet/IEEE 802.3u protocol 1350 may be used for transmitting and receiving information from the computer system to the complex communications components of the Internet. Within cloud 1310, which represents the Internet, many additional types of protocols may be used for transferring the data between the client computer and server computer.

Consider the sending of a message, via the HTTP protocol, from the client computer to the server computer. An application program generally makes a system call to the operating system and includes, in the system call, an indication of the recipient to whom the data is to be sent as well as a reference to a buffer that contains the data. The data and other information are packaged together into one or more HTTP datagrams, such as datagram 1352. The datagram may generally include a header 1354 as well as the data 1356, encoded as a sequence of bytes within a block of memory. The header 1354 is generally a record composed of multiple byte-encoded fields. The call by the application program to an application-layer system call is represented in FIG. 13 by solid vertical arrow 1358. The operating system employs a transport-layer protocol, such as TCP, to transfer one or more application-layer datagrams that together represent an application-layer message. In general, when the application-layer message exceeds some threshold number of bytes, the message is sent as two or more transport-layer messages. Each of the transport-layer messages 1360 includes a transport-layer-message header 1362 and an application-layer datagram 1352. The transport-layer header includes, among other things, sequence numbers that allow a series of application-layer datagrams to be reassembled into a single application-layer message. The transport-layer protocol is responsible for end-to-end message transfer independent of the underlying network and other communications subsystems, and is additionally concerned with error control, segmentation, as discussed above, flow control, congestion control, application addressing, and other aspects of reliable end-to-end message transfer. The transport-layer datagrams are then forwarded to the Internet layer via system calls within the operating system and are embedded within Internet-layer datagrams 1364, each including an Internet-layer header 1366 and a transport-layer datagram. The Internet layer of the protocol stack is concerned with sending datagrams across the potentially many different communications media and subsystems that together comprise the Internet. This involves routing of messages through the complex communications systems to the intended destination. The Internet layer is concerned with assigning unique addresses, known as “IP addresses,” to both the sending computer and the destination computer for a message and routing the message through the Internet to the destination computer. Internet-layer datagrams are finally transferred, by the operating system, to communications hardware, such as a NIC, which embeds the Internet-layer datagram 1364 into a link-layer datagram 1370 that includes a link-layer header 1372 and generally includes a number of additional bytes 1374 appended to the end of the Internet-layer datagram. The link-layer header includes collision-control and error-control information as well as local-network addresses. The link-layer packet or datagram 1370 is a sequence of bytes that includes information introduced by each of the layers of the protocol stack as well as the actual data that is transferred from the source computer to the destination computer according to the application-layer protocol.

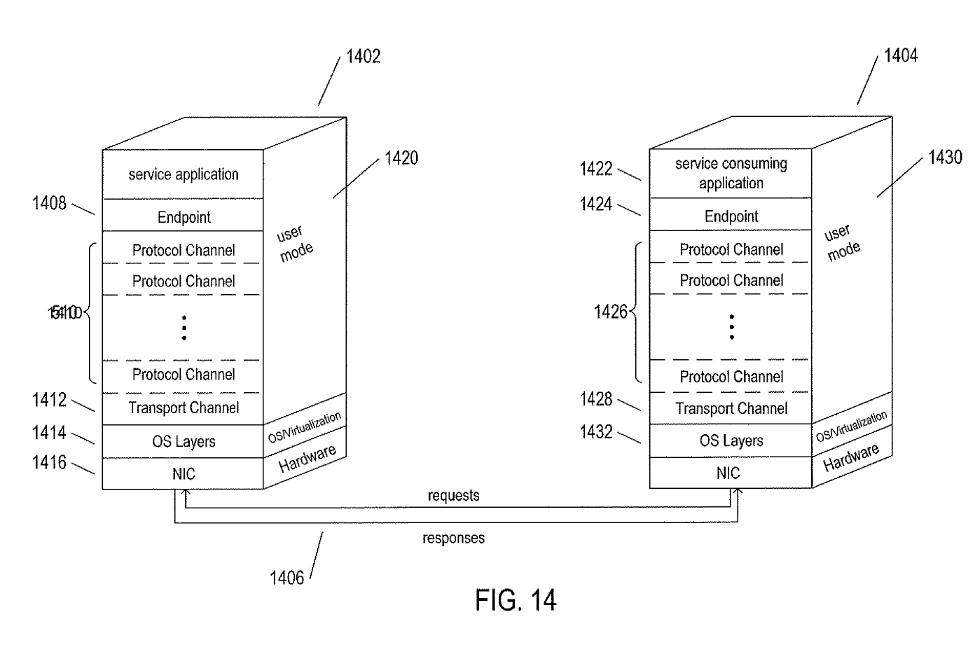

FIG. 14 illustrates another model for network communications used to interconnect consumers of services with service-providing applications running within server computers. The Windows Communication Foundation (“WCF”) model for network communications used to interconnect consumers of services with service-providing applications running within server computers. In FIG. 14, a server computer 1402 is shown to be interconnected with a service-consuming application running on a user computer 1404 via communications stacks of the WCF that exchange data through a physical communications medium or media 1406. As shown in FIG. 14, the communications are based on the client/server model in which the service-consuming application transmits requests to the service application running on the service computer and the service application transmits responses to those requests back to the service-consuming application. The communications stack on the server computer includes an endpoint 1408, a number of protocol channels 1410, a transport channel 1412, various lower-level layers implemented in an operating system or both in an operating system and a virtualization layer 1414, and the hardware NIC peripheral device 1416. Similar layers reside within the user computer 1404. As also indicated in FIG. 14, the endpoint, protocol channels, and transport channel all execute in user mode, along with the service application 1420 within the server computer 1402 and, on the user computer, the service-consuming application 1422, endpoint 1424, protocol channels 1426, and transport channel 1428 also execute in user mode 1430. The OS layers 1414 and 1432 execute either in an operating system or in a guest operating system and underlying virtualization layer.

An endpoint (1408 and 1424) encapsulates the information and logic needed by a service application to receive requests from service consumers and respond to those requests, on the server side, and encapsulate the information and logic needed by a client to transmit requests to a remote service application and receive responses to those requests. Endpoints can be defined either programmatically or in Extensible Markup Language (“XML”) configuration files. An endpoint logically consists of an address represented by an endpoint address class containing a universal resource identifier (“URI”) property and an authentication property, a service contract, and a binding that specifies the identities and orders of various protocol channels and the transport channel within the communications stack underlying the endpoint and overlying the various lower, operating-system- or guest-operating-system layers and the NIC hardware. The contract specifies a set of operations or methods supported by the endpoint. The data type of each parameter or return value in the methods associated with an endpoint are associated with a data-contract attribute that specifies how the data type is serialized and deserialized. Each protocol channel represents one or more protocols applied to a message or packet to achieve one of various different types of goals, including security of data within the message, reliability of message transmission and delivery, message formatting, and other such goals. The transport channel is concerned with transmission of data streams or datagrams through remote computers, and may include error detection and correction, flow control, congestion control, and other such aspects of data transmission. Well-known transport protocols include the hypertext transport protocol (“HTTP”), the transmission control protocol (“TCP”), the user datagram protocol (“UDP”), and the simple network management protocol (“SNMP”). In general, lower-level communications tasks, including Internet-protocol addressing and routing, are carried out within the operating-system- or operating-system-and-virtualization layers 1414 and 1432.

The Open Systems Interconnection (“OSI”) model is often used to describe network communications. The OSI model includes seven different layers, including: (1) a physical layer, L1, that describes a physical communications component, including a communications medium and characteristics of the signal transmitted through the medium; (2) a data-link layer, L2, that describes datagram exchange over the L1 layer and physical address; (3) a network layer, L3, that describes packet and datagram exchange through the L2 layer, including oath determination and logical addressing; (4) a transport layer, L4, that describes end-to-end connection of two communicating entities, reliability, and flow control; (5) a sessions layer, L5, that describes management of sessions, or multi-packet data transmission contexts; and (6) a presentation layer, L6, that describes data representation, data encryption, and machine-independent data; and an application layer, L7, that describes the interconnection of applications, including client and server applications.

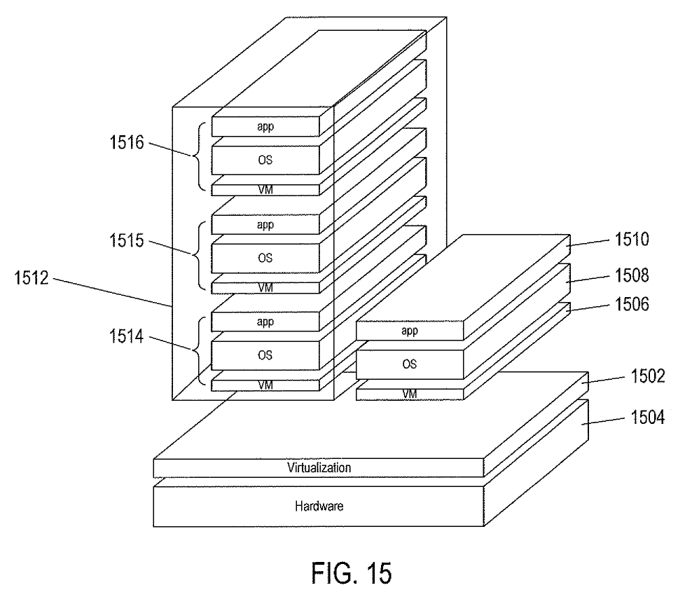

FIG. 15 illustrates a virtual application. As discussed above, virtualization can be viewed as a layer 1502 above the hardware layer 1504 of a computer system that supports execution of a virtual machine layer 1506, in turn supporting execution of an operating system 1508 and one or more application programs 1510 executing in an execution environment provided by the operating system, virtual machine, virtualization layer, and hardware. Another abstraction provided by a virtualization layer is a virtual application or vApp. A vApp 1512 is a resource container that includes one or more virtual machines that are grouped together to form an application. In the example shown in FIG. 15, vApp 1512 includes three different virtual-machine/OS/application entities 1514-1516. These three different entities may include, as one example, a web front end server and two database servers. The computational entities within a vApp can be easily deployed and started up and shut down, in similar fashion to the deployment, starting up, and shutting down of individual virtual machines. The vApp also provides an additional layer of abstraction within a virtualized computing environment that may be associated with a vApp-specific security layer to allow securing of groups of virtual machines under a common security scheme.

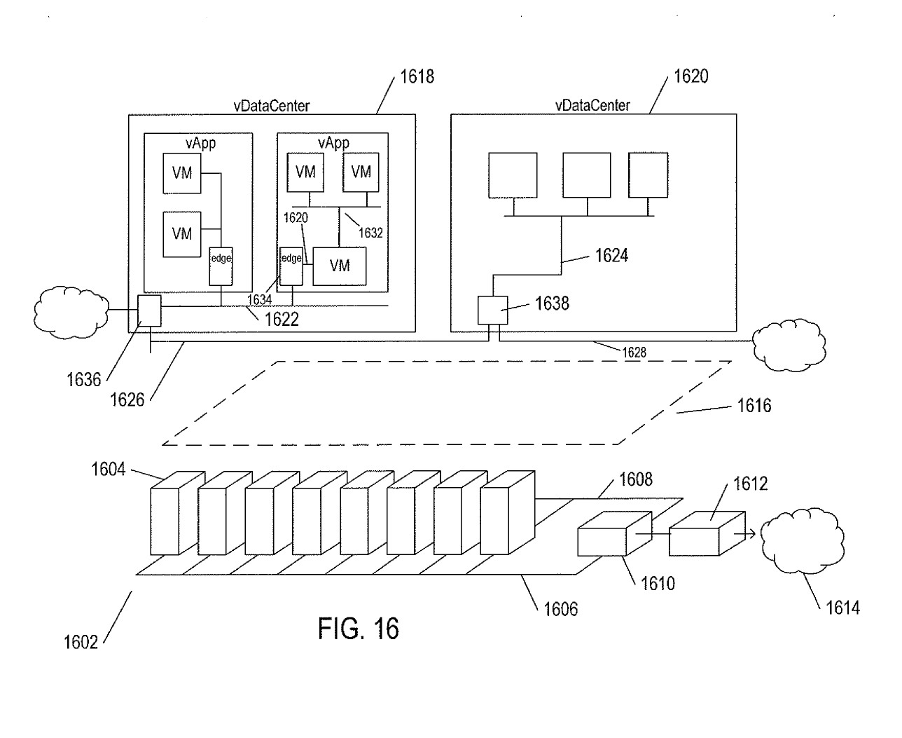

Just as physical data-storage devices and physical servers are virtualized by a virtualization layer, the networking resources within a physical data center are also virtualized by a virtualization layer to provide various types of virtualized networking facilities. FIG. 16 illustrates virtualization of networking facilities within a physical data center. As shown in FIG. 16, a physical data center 1602 may include a large number of enclosures containing multiple servers, such as enclosure 1604, and network-attached data-storage subsystems linked together by several local-area networks 1606 and 1608 interconnected through bridging, switching, firewall, and load-balancing appliances 1610 connected to a VPN gateway appliance 1612 through which the physical data center is interconnected with the Internet 1614 and other wide-area networks. The virtualization layer 1616, as discussed above, creates multiple virtual data centers 1618 and 1620 that execute within the physical data center, each having one or more internal organization networks 1622 and 1624 that allow intercommunication between virtual machines and vApps executing within the data centers and that may also provide interconnection with remote computational entities via virtual external networks 1626 and 1628 that interconnect the internal organization virtual networks 1622 and 1624 with the Internet and other wide-area networks. In addition, there may be internal networks, including networks 1630 and 1632, within individual vApps. Isolated virtual internal vApp networks, such as internal virtual network 1632, allow the virtual machines within a vApp to intercommunicate while other types of virtual internal networks, including routed virtual internal networks, such as virtual network 1632, provide connectivity between one or more virtual machines executing within the vApp to other virtual machines executing within a given virtual data center as well as remote machines via the virtual organization network 1632 and virtual external network 1626. The virtual internal routed network 1630 is associated with an edge virtual appliance 1634 that runs as a virtual machine within the virtual data center. The edge appliance provides a firewall, isolation of the sub-network within the vApp from the organization of virtual network 1622 and other networks to which it is connected, and a variety of networking services, including virtual private network connections to other edge appliances, network address translation to allow virtual machines within the vApp to intercommunicate with remote computational entities, and dynamic host configuration protocol facilities (“DHCP”). Virtual private networks employ encryption and other techniques to create an isolated, virtual network interconnecting two or more computational entities within one or more communications networks, including local area networks and wide-area networks, such as the Internet. One type of VPN is based on the secure sockets layer and is referred to as the secure socket layer virtual private network (“SSL VPN”). Another type of VPN is referred to as an Internet-protocol-security VPN (“IPsec”).

In general, an edge appliance isolates an interior sub-network, on one side of the edge appliance, from an exterior network, such as the Internet. Computational entities, such as virtual machines, within the interior sub-network can use local network addresses that are mapped, by the edge appliance, to global Internet addresses in order to provide connectivity between the edge appliance and computational entities within the interior sub-network to remote computer systems. An edge appliance essentially multiplex a small number of global network addresses among the computational entities within the sub-network, in many cases using pools of port numbers distributed within the internal sub-network. Just as edge appliance 1634 provides gateway services and isolation to the computational entities interconnected by a virtual routed interior network 1630 within a vApp, additional edge appliances 1636 and 1638 may provide similar gateway services to all the computational entities interconnected by an organization virtual network 1622 and 1624 within virtual data centers 1618 and 1620, respectively.

### Inter-Cloud VPNs Created and Managed by a Virtual Cloud-Connector Server and Virtual Cloud-Connector Nodes

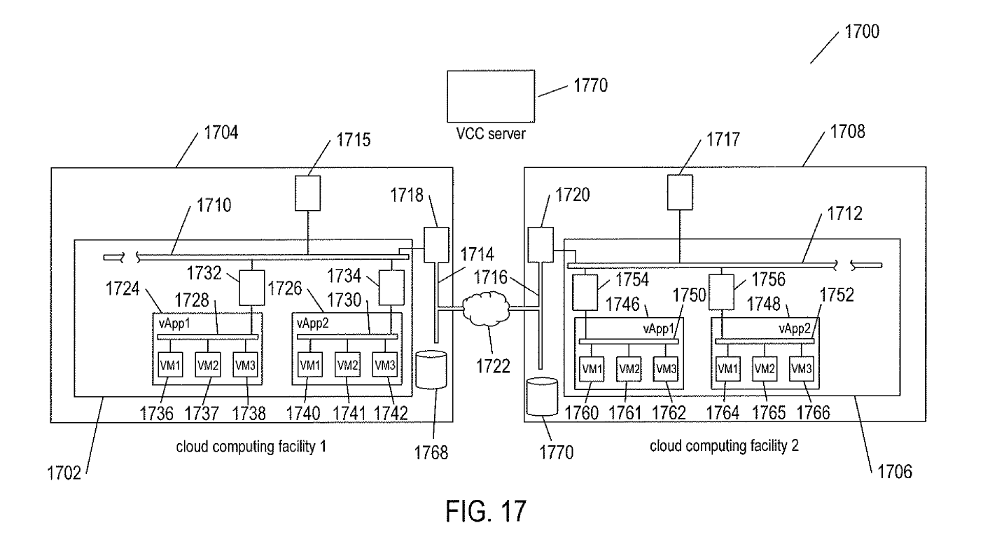

FIG. 17 shows an organization virtual data center 1702 in a first cloud-computing facility 1704 and an organization virtual data center 1706 in a second cloud-computing facility 1708 that is used, in the following discussion, as an example multi-cloud environment 1700 in which a VPN is created. In this example, the same organization controls both virtual data centers 1702 and 1706. The first cloud-computing facility 1704 (“first cloud”) may be a private cloud-computing facility that is owned and managed by the organization and the second cloud-computing facility 1708 (“second cloud”) may be a public cloud-computing facility from which the organization rents computational resources that are virtualized by the organization virtual data center 1706.

Each VDC 1702 and 1704 includes a virtual organization network 1710 and 1712, respectively. Each virtualization organization network interconnects to a virtual external network 1714 and 1716, respectively, through an organization edge appliance 1718 and 1720, respectively. Each VDC also includes a VCC node. 1715 and 1717, respectively. The virtual external networks are implemented within one or more physical networks that provide interconnection of the external networks through the Internet 1722. VDC 1702 within the first cloud includes two vApps 1724 and 1726, each with an internal virtual routed vApp network 1728 and 1730, respectively, that each interconnects with the virtual organization network 1710 through an edge appliance 1732 and 1734, respectively. Each vApp 1724 and 1726 includes three virtual machines 1736-1738 and 1740-142, respectively. The second VDC 1706 in the second cloud 1708 also includes two vApps 1746 and 1748, each with an internal virtual routed vApp network 1750 and 1752, respectively, that each interconnects with the virtual organization network 1712 through an edge appliance 1754 and 1756, respectively. Each vApp 1746 and 1748 includes three virtual machines 1760-1762 and 1764-1766, respectively. Both the VDC 1706 in the first cloud and the VDC 1708 in the target cloud include catalog facilities 1768 and 1770, respectively, that allows the organization to publish vApp templates and VM templates for access by VDCs in remote clouds. The multi-cloud resources are managed by a VCC server 1770, similar to the VCC server 1014 in FIG. 10, in cooperation with VCC nodes 1715 and 1717. The VCC server may be located in either of the two cloud-computing facilities 1702 and 1706 or in another cloud-computing facility or location not shown in FIG. 17.

The Internet Protocol Security (“IPsec”) protocol is a communications protocol for securing IP communications. IPsec authenticates and encrypts each IP packet of a communication session, with information for mutual authentication as well as encryption keys exchanged between communications endpoints prior to initiation of a communications session. The endpoints can be host computers and/or security gateways. IPsec supports creation of Layer 2 tunnels to support virtual private networks. Higher level multi-packet messages, handled as Layer 3 entities by higher-level protocol layers, are protected by the Layer 2 encryption of datagrams without modifications to the higher-level protocols.

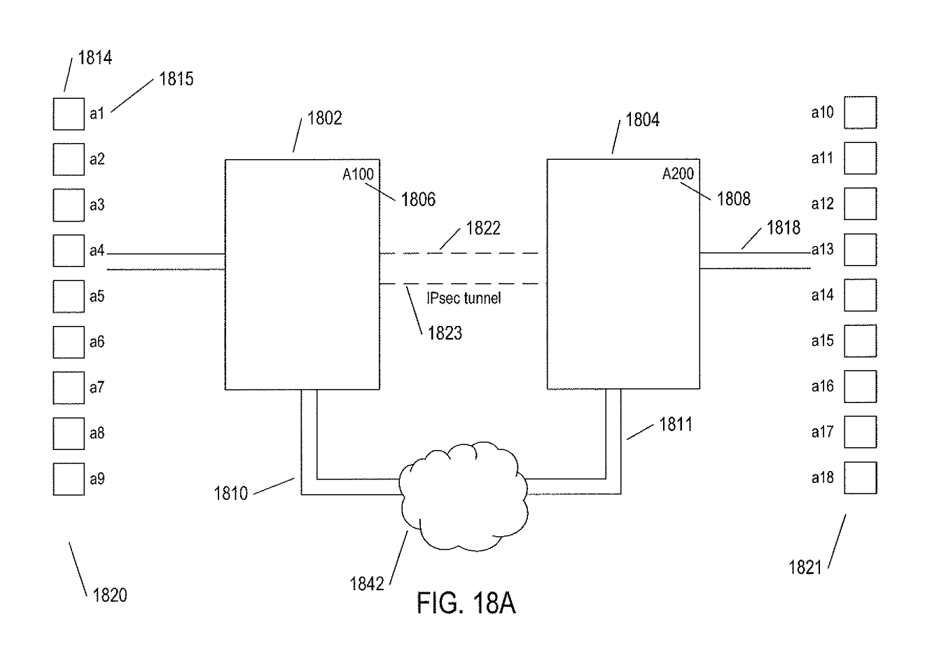

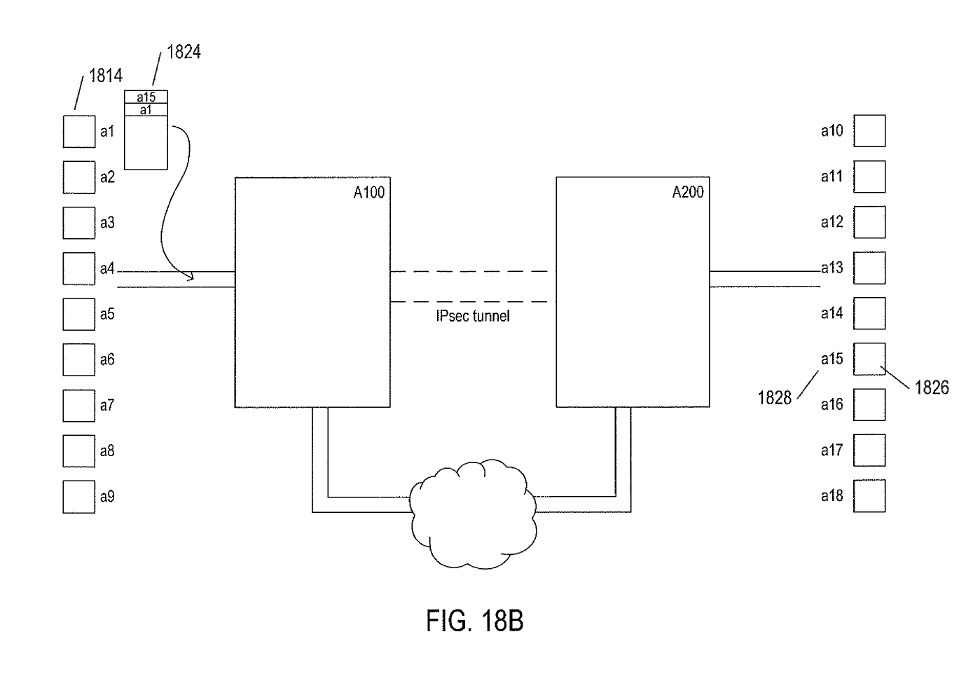

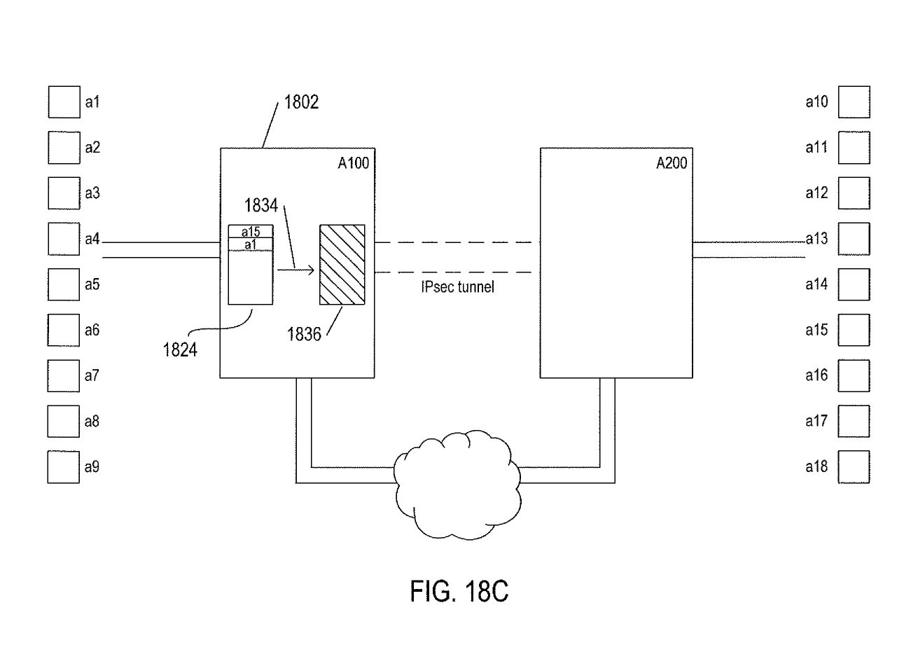

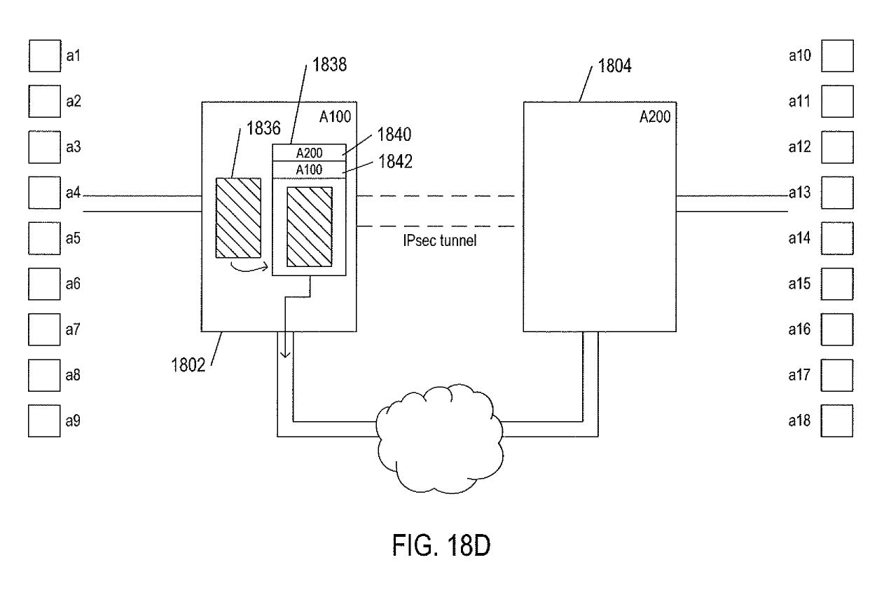

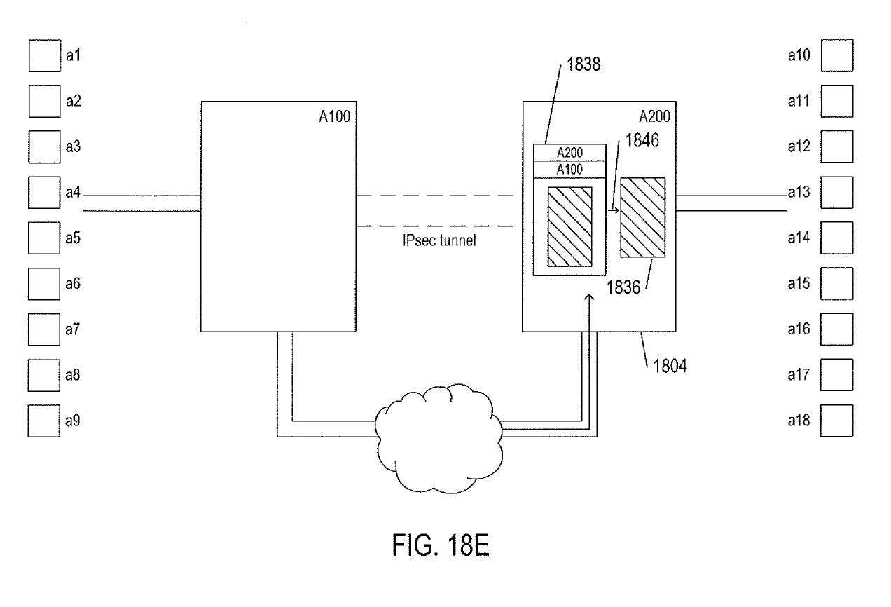

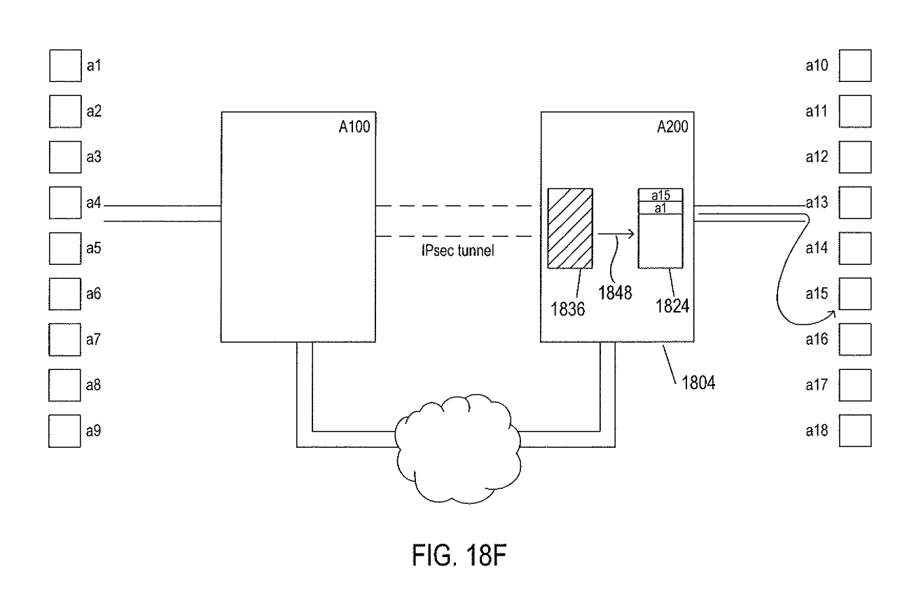

FIGS. 18A-F illustrate an IPsec tunnel. FIG. 18A shows two organization edge appliances 1802 and 1804 within cloud-computing facilities, such as organization edge appliances 1718 and 1720 in FIG. 17. The two organization edge appliances 1802 and 1804 are associated with IP addresses A100 (1806 in FIG. 18A) and A200 (1808 in FIG. 18A), respectively. These addresses are short, hypothetical addresses used for simplicity of illustration. Actual IP addresses are 32-bit or 128-bit integers that are often displayed as groups of decimal digits separated by commas. The two organization edge appliances 1802 and 1804 are connected, through local and wide-area networks 1810-1811, to one another through the Internet 1812, just as organization edge appliances 1718 and 1720 in FIG. 17 are interconnected to the Internet 1722 through virtual external networks 1714 and 1716. FIG. 18A also shows numerous VMs as small rectangles, such as rectangle 1814, each associated with an internal, IP-like address, such as the address represented by the symbol string “a1” associated with VM 1814. The internal, IP-like addresses are used by the VMs for sending and receiving packets or datagrams to and from other VMs interconnected by a virtual private network that includes internal virtual networks 1816 and 1818 within VDCs that execute within each cloud-computing facility, logic and routing tables within organization edge appliances 1802 and 1804, and the IPsec Layer 2 tunnel. The VMs in the left-hand column 1820 in FIG. 18A can be considered to represent VMs 1736-1738 and 1740-1742 that execute within VDC 1702 in the example of FIG. 17 and the VMs in the right-hand column 1821 in FIG. 18A can be considered to represent VMs 1760-1762 and 1764-1766 that execute within VDC 1706 in the example of FIG. 17. In FIG. 18A, the IPsec tunnel is represented by dashed lines 1822-1823 to indicate that the IPsec tunnel is an abstraction implemented with logic, data structures, and physical computing and networking hardware.

The internal IP addresses used by VMs for communication with other VMs within the virtual private network are distributed to the VMs from a pool of internal IP addresses allocated to the virtual private network by a VCC server, through VCC nodes, to organization edge appliances 1802 and 1804 as well as to edge appliances associated with vApps and VMs that handle packet or datagram traffic on behalf of the VMs that participate in the virtual private network. The organization edge appliances and/or edge appliances associated with vApps and VMs that handle packet or datagram traffic on behalf of the VMs that participate in the virtual private network also include various encoded policies and rules that govern how the virtual private network operates as well as routing tables that are used to direct datagrams or packets to their destinations along paths of local and wide-area networks linked through routers, bridges, and other computational devices.

FIGS. 18B-F illustrate operation of the IPsec tunnel and virtual private network. In FIG. 18B, VM 1814 sends a datagram through a local virtual internal vApp network to VM 1826 associated with internal VPN address “a15” 1828. The datagram 1824 includes a header that, in turn, includes a destination address 1830 and a source address 1832. The destination address “a15” directs the datagram to VM 1826 and the source address “a1” indicates that VM 1814 is the source VM of the datagram.

In FIG. 18C, the datagram 1824 is routed through the VDC virtual network or networks to organization edge appliance 1802. The organization edge appliance 1802 determines, from internal routing tables, that internal VPN address “a15” is located in a remote cloud computing facility and therefore needs to be transmitted to that remote cloud-computing facility through the IPsec tunnel. As a first step in IPsec tunnel transmission, the datagram is encrypted, as shown by arrow and cross-hatched encrypted datagram 1836. An encryption key associated with the IPsec tunnel is employed to encrypt the datagram. Next, as shown in FIG. 18D, the encrypted datagram 1836 is packaged within a carrier datagram 1838 for transmission through the Internet to the remote cloud computing facility. The carrier datagram 1838 includes a header that, in turn, includes a destination address 1840 and a source address 1842. The destination address “A200” directs the carrier datagram to organization edge appliance 1804 in the remote cloud-computing facility and the source address “A100” indicates that organization edge appliance 1802 the source of the carrier datagram. In FIG. 18E, the carrier datagram has been transmitted through the Internet to organization edge appliance 1804, where, as indicated by arrow 1846, encrypted datagram 1836 is extracted from the carrier datagram 1838. Encrypted datagram 1836 is then decrypted, using a decryption key associated with the IPsec tunnel, as indicated by arrow 1848, to recover the original datagram 1824 transmitted from VM 1814. Organization edge appliance 1804 then uses an internal routing table that includes entries for VPN addresses to direct the datagram through an appropriate internal virtual network to an edge appliance associated with the destination VM or a vApp that includes the destination VM 1826.

### Workflow-Based Cloud-Management Facility

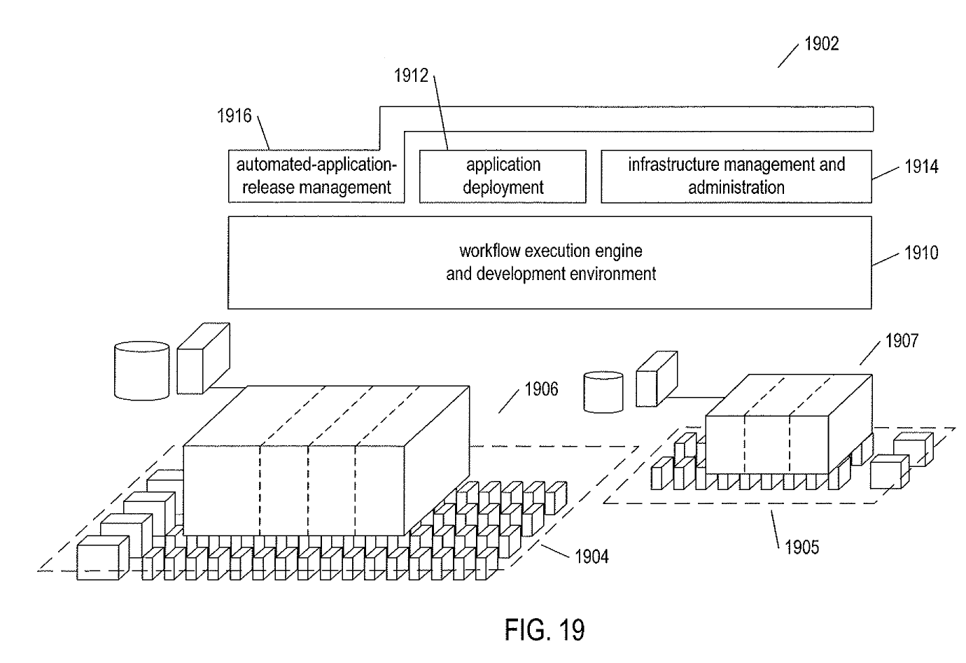

FIG. 19 a shows workflow-based cloud-management facility that has been developed to provide a powerful administrative and development interface to multiple multi-tenant cloud-computing facilities. The workflow-based management, administration, and development facility (“WFMAD”) is used to manage and administer private data centers, cloud-computing aggregations, and a variety of additional types of cloud-computing facilities as well as to deploy applications and continuously and automatically release complex applications on various types of cloud-computing aggregations. As shown in FIG. 19, the WFMAD 1902 is implemented above the physical hardware layers 1904 and 1905 and virtual data centers 1906 and 1907 of a cloud-computing facility or cloud-computing-facility aggregation. The WFMAD includes a workflow-execution engine and development environment 1910, an application-deployment facility 1912, an infrastructure-management-and-administration facility 1914, and an automated-application-release-management facility 1916. The workflow-execution engine and development environment 1910 provides an integrated development environment for constructing, validating, testing, and executing graphically expressed workflows, discussed in detail below. Workflows are high-level programs with many built-in functions, scripting tools, and development tools and graphical interfaces. Workflows provide an underlying foundation for the infrastructure-management-and-administration facility 1914, the application-development facility 1912, and the automated-application-release-management facility 1916. The infrastructure-management-and-administration facility 1914 provides a powerful and intuitive suite of management and administration tools that allow the resources of a cloud-computing facility or cloud-computing-facility aggregation to be distributed among clients and users of the cloud-computing facility or facilities and to be administered by a hierarchy of general and specific administrators. The infrastructure-management-and-administration facility 1914 provides interfaces that allow service architects to develop various types of services and resource descriptions that can be provided to users and clients of the cloud-computing facility or facilities, including many management and administrative services and functionalities implemented as workflows. The application-deployment facility 1912 provides an integrated application-deployment environment to facilitate building and launching complex cloud-resident applications on the cloud-computing facility or facilities. The application-deployment facility provides access to one or more artifact repositories that store and logically organize binary files and other artifacts used to build complex cloud-resident applications as well as access to automated tools used, along with workflows, to develop specific automated application-deployment tools for specific cloud-resident applications. The automated-application-release-management facility 1916 provides workflow-based automated release-management tools that enable cloud-resident-application developers to continuously generate application releases produced by automated deployment, testing, and validation functionalities. Thus, the WFMAD 1902 provides a powerful, programmable, and extensible management, administration, and development platform to allow cloud-computing facilities and cloud-computing-facility aggregations to be used and managed by organizations and teams of individuals.

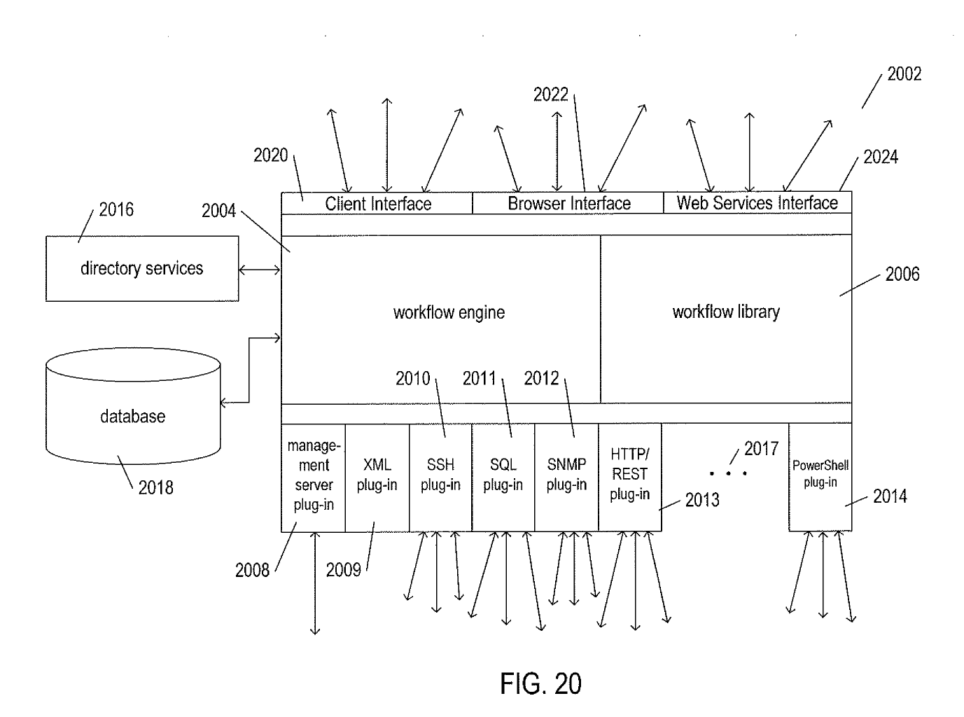

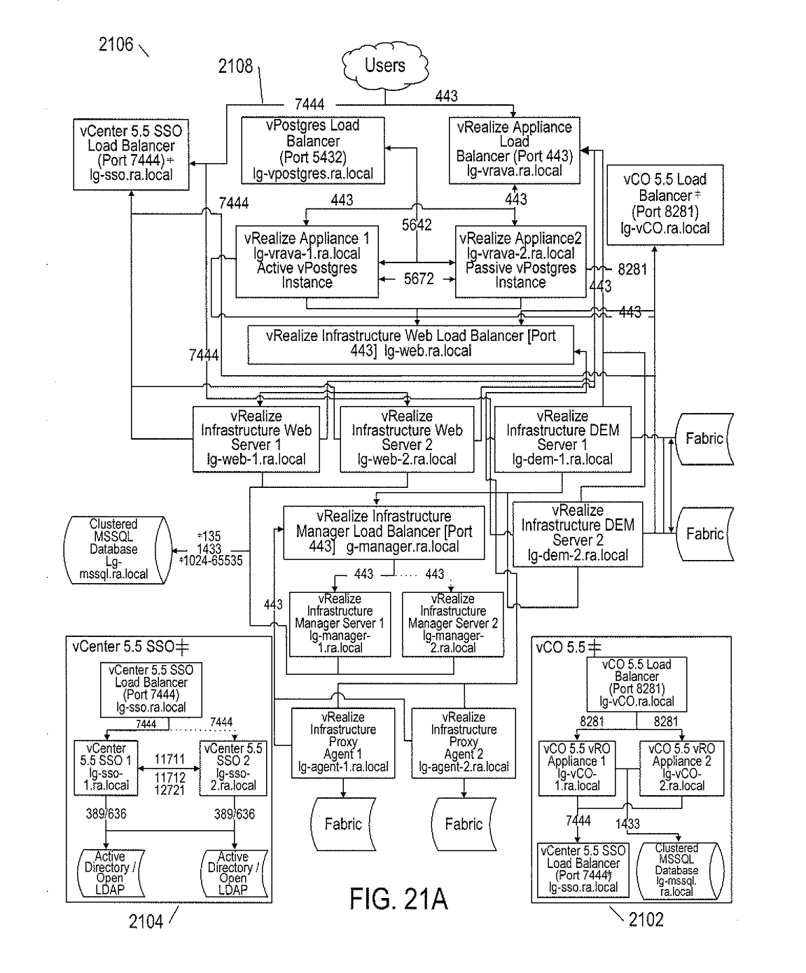

Next, the workflow-execution engine and development environment is discussed in grater detail. FIG. 20 provides an architectural diagram of the workflow-execution engine and development environment. The workflow-execution engine and development environment 2002 includes a workflow engine 2004, which executes workflows to carry out the many different administration, management, and development tasks encoded in workflows that comprise the functionalities of the WFMAD. The workflow engine, during execution of workflows, accesses many built-in tools and functionalities provided by a workflow library 2006. In addition, both the routines and functionalities provided by the workflow library and the workflow engine access a wide variety of tools and computational facilities, provided by a wide variety of third-party providers, through a large set of plug-ins 2008-2014. Note that the ellipses 2016 indicate that many additional plug-ins provide, to the workflow engine and workflow-library routines, access to many additional third-party computational resources. Plug-in 2008 provides for access, by the workflow engine and workflow-library routines, to a cloud-computing-facility or cloud-computing-facility-aggregation management server, such as a cloud director or VCC server. The XML plug-in 2009 provides access to a complete document object model (“DOM”) extensible markup language (“XML”) parser. The SSH plug-in 2010 provides access to an implementation of the Secure Shell v2 (“SSH-2”) protocol. The structured query language (“SQL”) plug-in 2011 provides access to a Java database connectivity (“JDBC”) API that, in turn, provides access to a wide range of different types of databases. The simple network management protocol (“SNMP”) plug-in 2012 provides access to an implementation of the SNMP protocol that allows the workflow-execution engine and development environment to connect to, and receive information from, various SNMP-enabled systems and devices. The hypertext transfer protocol (“HTTP”)/representational state transfer (‘REST”) plug-in 2013 provides access to REST web services and hosts. The PowerShell plug-in 2014 allows the workflow-execution engine and development environment to manage PowerShell hosts and run custom PowerShell operations. The workflow engine 2004 additionally accesses directory services 2016, such as a lightweight directory access protocol (“LDAP”) directory, that maintain distributed directory information and manages password-based user login. The workflow engine also accesses a dedicated database 2018 in which workflows and other information are stored. The workflow-execution engine and development environment can be accessed by clients running a client application that interfaces to a client interface 2020, by clients using web browsers that interface to a browser interface 2022, and by various applications and other executables running on remote computers that access the workflow-execution engine and development environment using a REST or small-object-access protocol (“SOAP”) via a web-services interface 2024. The client application that runs on a remote computer and interfaces to the client interface 2020 provides a powerful graphical user interface that allows a client to develop and store workflows for subsequent execution by the workflow engine. The user interface also allows clients to initiate workflow execution and provides a variety of tools for validating and debugging workflows. Workflow execution can be initiated via the browser interface 2022 and web-services interface 2024. The various interfaces also provide for exchange of data output by workflows and input of parameters and data to workflows.

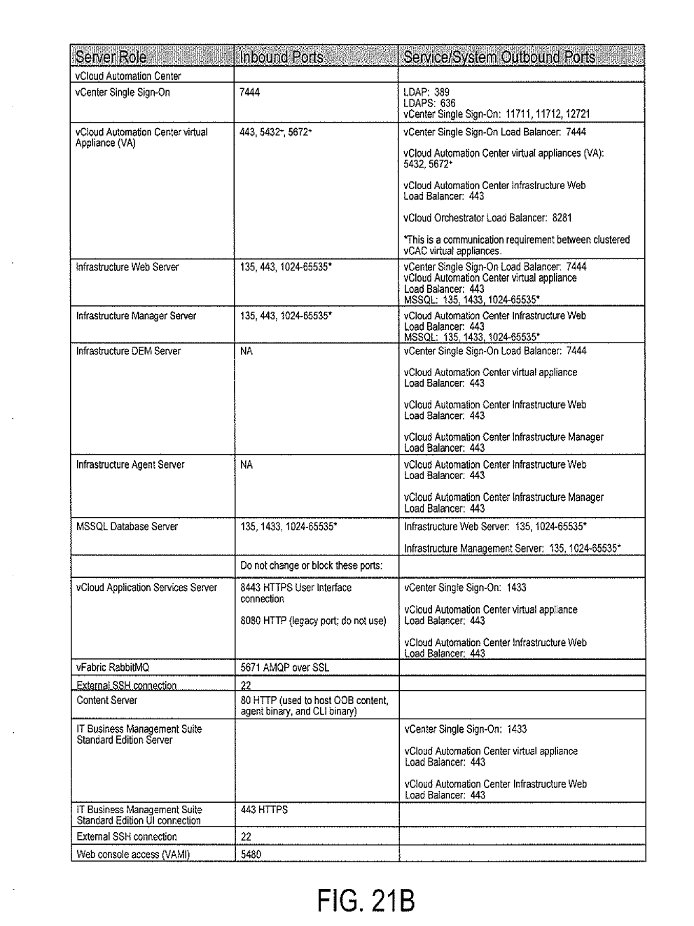

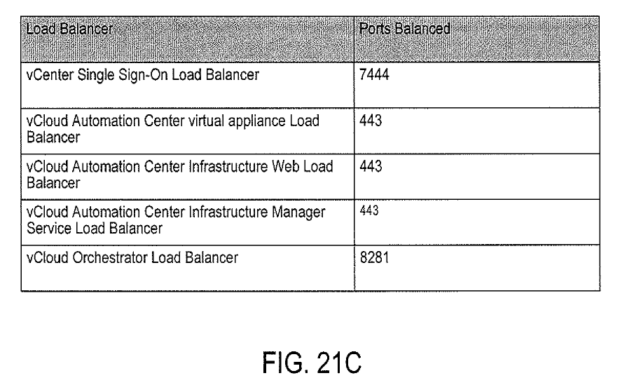

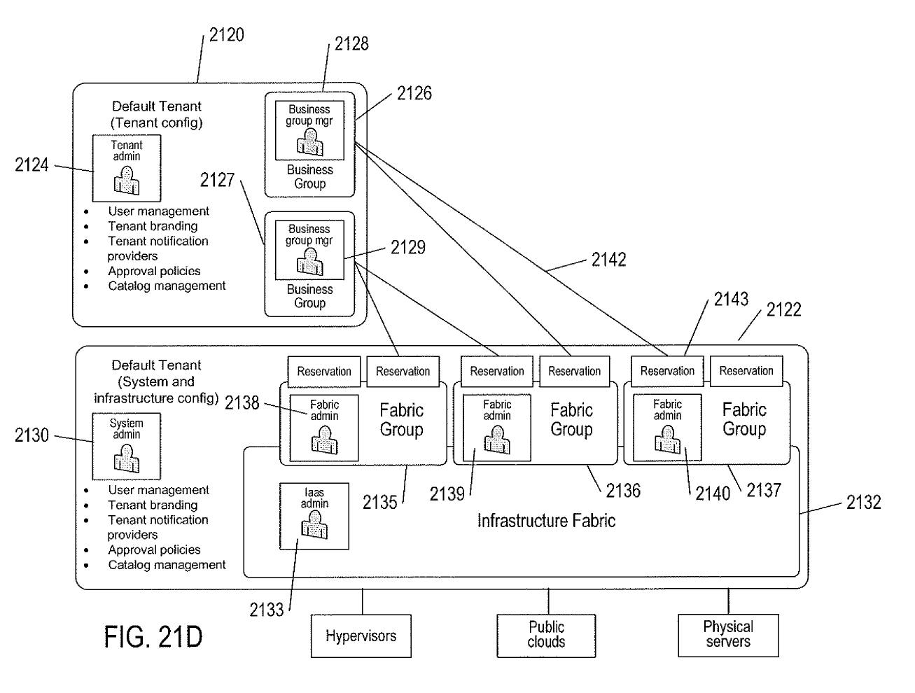

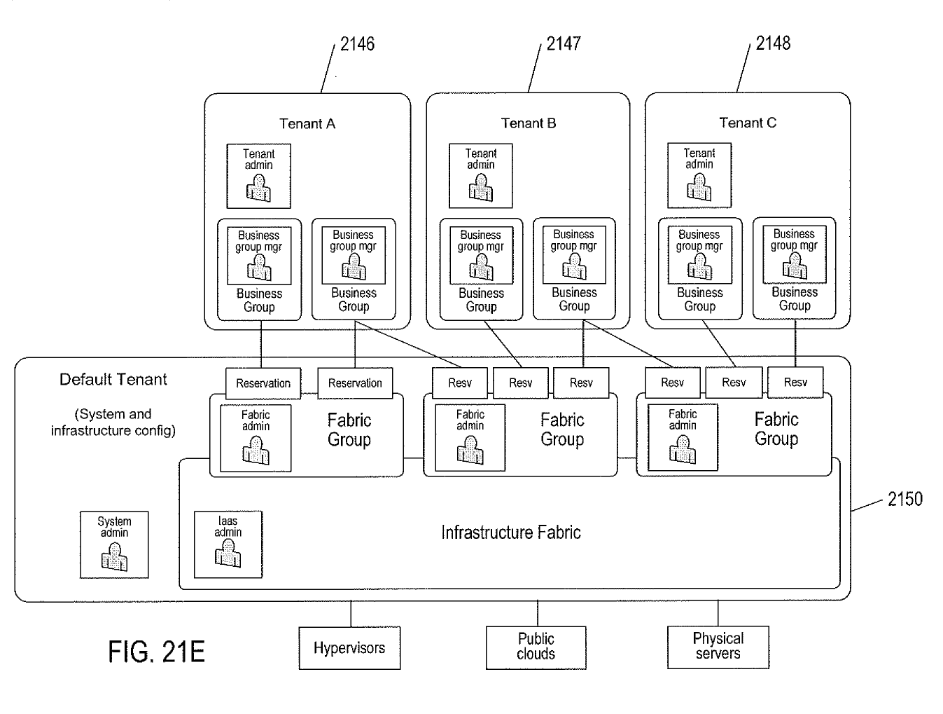

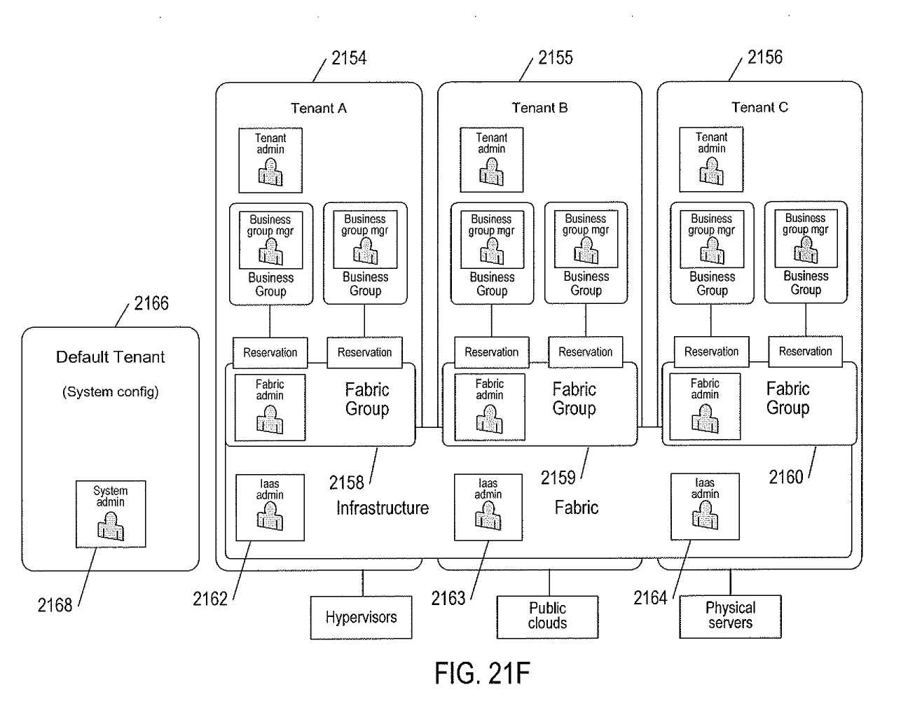

FIGS. 21A-C illustrate an example implementation and configuration of virtual appliances within a cloud-computing facility that implement the workflow-based management and administration facilities of the above-described WFMAD. FIG. 21A shows a configuration that includes the workflow-execution engine and development environment 2102, a cloud-computing facility 2104, and the infrastructure-management-and-administration facility 2106 of the above-described WFMAD. Data and information exchanges between components are illustrated with arrows, such as arrow 2108, labeled with port numbers indicating inbound and outbound ports used for data and information exchanges. FIG. 21B provides a table of servers, the services provided by the server, and the inbound and outbound ports associated with the server. Table 21C indicates the ports balanced by various load balancers shown in the configuration illustrated in FIG. 21A. It can be easily ascertained from FIGS. 21A-C that the WFMAD is a complex, multi-virtual-appliance/virtual-server system that executes on many different physical devices of a physical cloud-computing facility.

FIGS. 21D-F illustrate the logical organization of users and user roles with respect to the infrastructure-management-and-administration facility of the WFMAD (1914 in FIG. 19). FIG. 21D shows a single-tenant configuration, FIG. 21E shows a multi-tenant configuration with a single default-tenant infrastructure configuration, and FIG. 21F shows a multi-tenant configuration with a multi-tenant infrastructure configuration. A tenant is an organizational unit, such as a business unit in an enterprise or company that subscribes to cloud services from a service provider. When the infrastructure-management-and-administration facility is initially deployed within a cloud-computing facility or cloud-computing-facility aggregation, a default tenant is initially configured by a system administrator. The system administrator designates a tenant administrator for the default tenant as well as an identity store, such as an active-directory server, to provide authentication for tenant users, including the tenant administrator. The tenant administrator can then designate additional identity stores and assign roles to users or groups of the tenant, including business groups, which are sets of users that correspond to a department or other organizational unit within the organization corresponding to the tenant. Business groups are, in turn, associated with a catalog of services and infrastructure resources. Users and groups of users can be assigned to business groups. The business groups, identity stores, and tenant administrator are all associated with a tenant configuration. A tenant is also associated with a system and infrastructure configuration. The system and infrastructure configuration includes a system administrator and an infrastructure fabric that represents the virtual and physical computational resources allocated to the tenant and available for provisioning to users. The infrastructure fabric can be partitioned into fabric groups, each managed by a fabric administrator. The infrastructure fabric is managed by an infrastructure-as-a-service (“IAAS”) administrator. Fabric-group computational resources can be allocated to business groups by using reservations.

FIG. 21D shows a single-tenant configuration for an infrastructure-management-and-administration facility deployment within a cloud-computing facility or cloud-computing-facility aggregation. The configuration includes a tenant configuration 2120 and a system and infrastructure configuration 2122. The tenant configuration 2120 includes a tenant administrator 2124 and several business groups 2126-2127, each associated with a business-group manager 2128-2129, respectively. The system and infrastructure configuration 2122 includes a system administrator 2130, an infrastructure fabric 2132 managed by an IAAS administrator 2133, and three fabric groups 2135-2137, each managed by a fabric administrator 2138-2140, respectively. The computational resources represented by the fabric groups are allocated to business groups by a reservation system, as indicated by the lines between business groups and reservation blocks, such as line 2142 between reservation block 2143 associated with fabric group 2137 and the business group 2126.

FIG. 21E shows a multi-tenant single-tenant-system-and-infrastructure-configuration deployment for an infrastructure-management-and-administration facility of the WFMAD. In this configuration, there are three different tenant organizations, each associated with a tenant configuration 2146-2148. Thus, following configuration of a default tenant, a system administrator creates additional tenants for different organizations that together share the computational resources of a cloud-computing facility or cloud-computing-facility aggregation. In general, the computational resources are partitioned among the tenants so that the computational resources allocated to any particular tenant are segregated from and inaccessible to the other tenants. In the configuration shown in FIG. 21E, there is a single default-tenant system and infrastructure configuration 2150, as in the previously discussed configuration shown in FIG. 21D.

FIG. 21F shows a multi-tenant configuration in which each tenant manages its own infrastructure fabric. As in the configuration shown in FIG. 21E, there are three different tenants 2154-2156 in the configuration shown in FIG. 21F. However, each tenant is associated with its own fabric group 2158-2160, respectively, and each tenant is also associated with an infrastructure-fabric IAAS administrator 2162-2164, respectively. A default-tenant system configuration 2166 is associated with a system administrator 2168 who administers the infrastructure fabric, as a whole.

System administrators, as mentioned above, generally install the WFMAD within a cloud-computing facility or cloud-computing-facility aggregation, create tenants, manage system-wide configuration, and are generally responsible for insuring availability of WFMAD services to users, in general. IAAS administrators create fabric groups, configure virtualization proxy agents, and manage cloud service accounts, physical machines, and storage devices. Fabric administrators manage physical machines and computational resources for their associated fabric groups as well as reservations and reservation policies through which the resources are allocated to business groups. Tenant administrators configure and manage tenants on behalf of organizations. They manage users and groups within the tenant organization, track resource usage, and may initiate reclamation of provisioned resources. Service architects create blueprints for items stored in user service catalogs which represent services and resources that can be provisioned to users. The infrastructure-management-and-administration facility defines many additional roles for various administrators and users to manage provision of services and resources to users of cloud-computing facilities and cloud-computing facility aggregations.

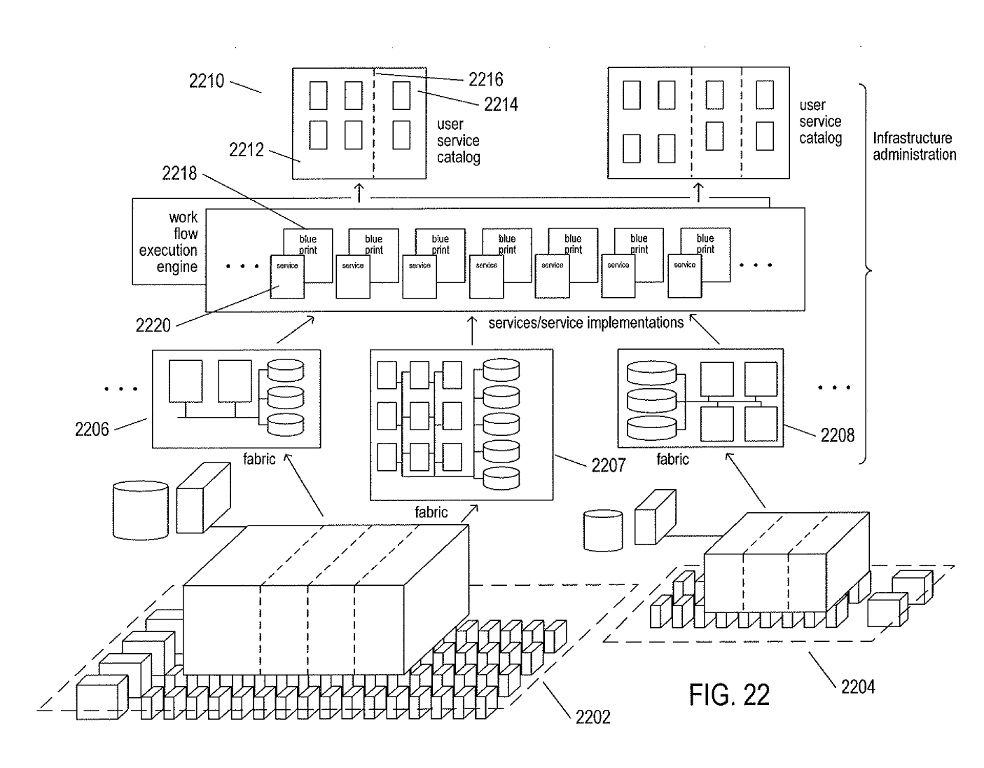

FIG. 22 illustrates the logical components of the infrastructure-management-and-administration facility (1914 in FIG. 19) of the WFMAD. As discussed above, the WFMAD is implemented within, and provides a management and development interface to, one or more cloud-computing facilities 2202 and 2204. The computational resources provided by the cloud-computing facilities, generally in the form of virtual servers, virtual storage devices, and virtual networks, are logically partitioned into fabrics 2206-2208. Computational resources are provisioned from fabrics to users. For example, a user may request one or more virtual machines running particular applications. The request is serviced by allocating the virtual machines from a particular fabric on behalf of the user. The services, including computational resources and workflow-implemented tasks, which a user may request provisioning of, are stored in a user service catalog, such as user service catalog 2210, that is associated with particular business groups and tenants. In FIG. 22, the items within a user service catalog are internally partitioned into categories, such as the two categories 2212 and 2214 and separated logically by vertical dashed line 2216. User access to catalog items is controlled by entitlements specific to business groups. Business group managers create entitlements that specify which users and groups within the business group can access particular catalog items. The catalog items are specified by service-architect-developed blueprints, such as blueprint 2218 for service 2220. The blueprint is a specification for a computational resource or task-service and the service itself is implemented by a workflow that is executed by the workflow-execution engine on behalf of a user.

### Extension of a Cloud-Management Facility that Manages the Infrastructure of a Private Data Center to Remote Infrastructure Provided by a Remote Cloud-Computing Facility

As discussed above, a cloud-management facility provides a management and administration facility for managing and administering the infrastructure of a private data center, virtualized data center, or aggregation of virtualized data centers and includes a graphical user interface through which system administrators access management and administration functionalities. The methods and systems disclosed in the current document are directed to extending a cloud-management facility, running within and managing a private data center, to remote infrastructure provided by a remote cloud-computing facility. In general, the remote cloud-computing facility is a public cloud-computing facility from which computational, communications, and storage services are contracted for by the organization that owns and manages the private data center, referred to below as “the owner.” This problem domain differs from that of managing a single data center or an aggregation of commonly owned cloud-computing-facilities because the remote infrastructure contracted for by the owner cannot be directly managed by the owner. Instead, the public cloud-computing facility provides infrastructure as a service to various clients. In essence, the extension of cloud-management-facility management to remote infrastructure provided by a public cloud-computing facility allows the cloud-management facility to use the remote infrastructure on an as-needed basis in order to handle overflow conditions within the private data center, such as temporary demands for local infrastructure that exceed the capacity of the private data center.

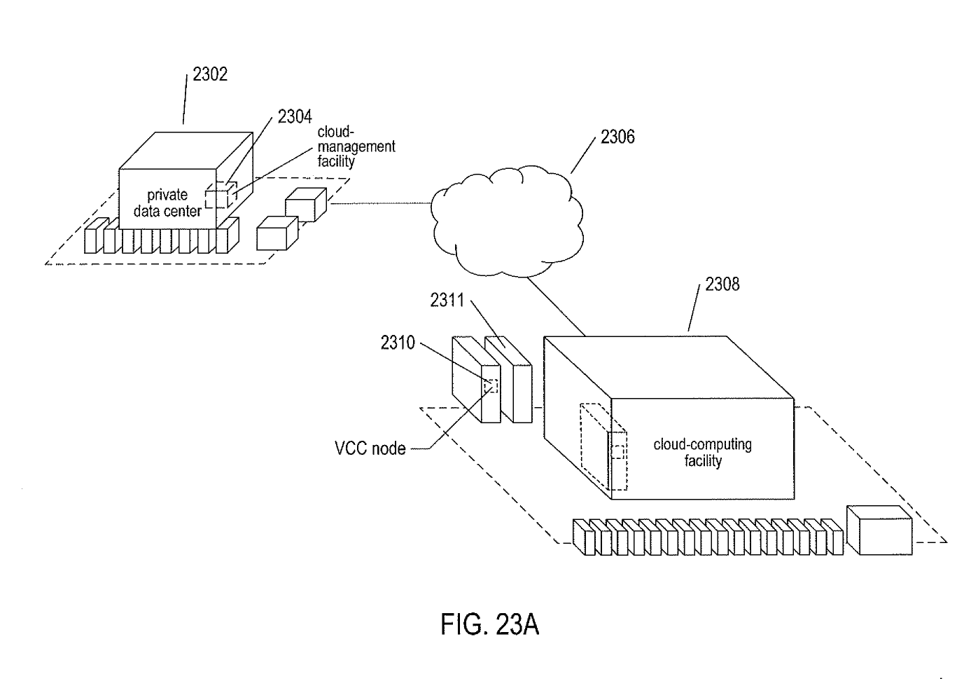

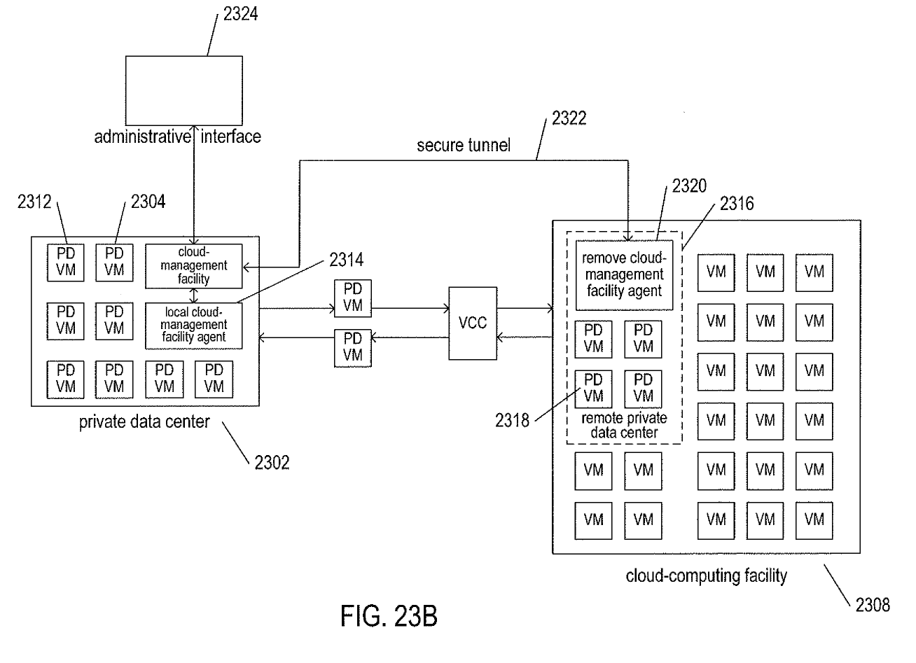

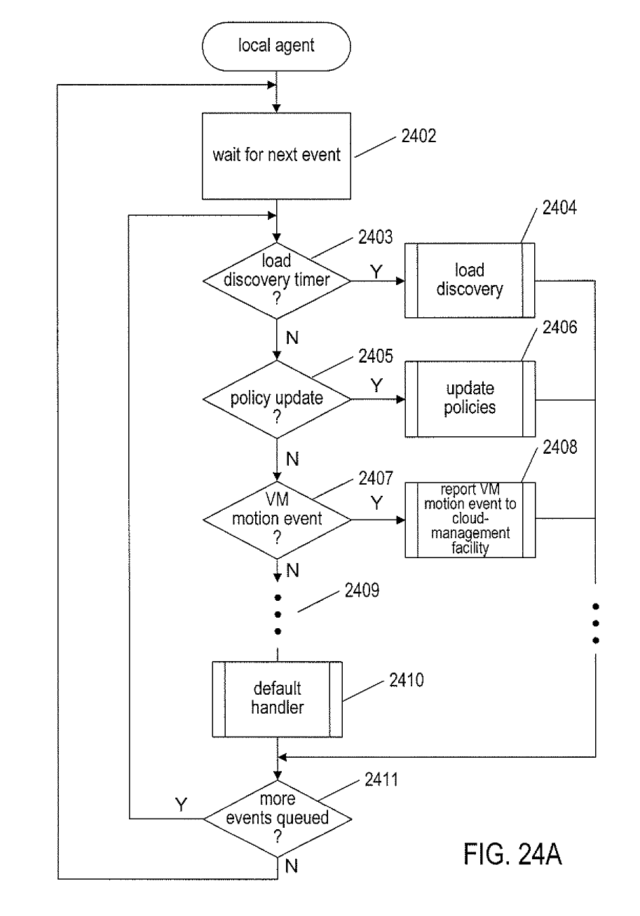

FIGS. 23A-B illustrate an example computing environment in which the currently disclosed methods and systems can be applied. As shown in FIG. 23A, a private data center 2302 is managed and administered via the above-discussed cloud-management facility 2304. The cloud-management facility allows system administrators to provision virtual machines and virtual applications, deploy applications within provisioned virtual machines, and coordinate automatic application releases. The private data center is connected, via communications media and systems, including the Internet 2306 or dedicated communications infrastructure, to a remote cloud-computing facility 2308 that provides infrastructure as a service to remote clients. The remote cloud-computing facility 2308 includes a VCC node 2310 and VCC server 2311, referred to collectively below as the VCC, and other management and aggregation components and facilities discussed above. The currently disclosed methods and systems allow the cloud-management facility 2304 within the private data center 2302 to allocate remote infrastructure in the cloud-computing facility and automatically move virtual machines executing within the private data center to the remote infrastructure allocated within the cloud-computing facility, under conditions in which there is insufficient capacity within the private data center for efficiently executing the VMs currently provisioned within the private data center and VMs for which provisioning has been requested from, or anticipated by, the cloud-management facility. In addition, VMs executing within the remote infrastructure are automatically moved back to the private data center when available capacity within the private data center for efficiently executing VMs allows for their return.

FIG. 23B illustrates extension of the cloud-management facility to what effectively constitutes a remote private data center allocated from infrastructure provided within the remote cloud-computing facility. In FIG. 23B, the private data center 2302 and remote cloud-computing facility 2308 are both shown as rectangles that include numerous provisioned and executing virtual machines, such as virtual machine 2312 within the private data center 2302, the cloud-management facility 2304, executed by one or more virtual machines within the private data center, a local cloud-management-facility agent 2314 within the private data center, and the remote private data center 2316 including a number of provisioned and executing virtual machines, such as virtual machine 2318, and a remote cloud-management-facility agent 2320. The cloud-management facility 2304 is connected with the remote cloud-management-facility agent 2320 by a secure tunnel 2322 provided by a communications service within the cloud-computing facility. The secure tunnel 2322 allows the cloud-management facility and remote cloud-management-facility agent to exchange commands and information so that the cloud-management facility can maintain state information for the virtual machines executing on the remote cloud-computing facility 2308 within the remote private data center 2316 and can issue various types of management commands to the remote virtual machines, including commands for scaling applications within the virtual machines, updating configurations of the applications and virtual machines, and other such administration commands. The local cloud-management-facility agent 2314 manages movement of virtual machines to and from the remote cloud-computing facility via the VCC executing within the remote cloud-computing facility. VMs executing within the private data center are suspended and moved to the remote cloud-computing facility, where their execution is resumed, by methods such as those discussed in the first subsection, above. The local cloud-management-facility agent 2314 is an extension of the cloud-management facility 2304 that automates movement of VMs back and forth between the private data center and the remote private data center 2316 allocated from remote infrastructure provided by the cloud-computing facility. The local cloud-management-facility agent is shown, in FIG. 23B, as a separate agent but, in various alternative implementations, may be implemented as modules or subcomponents within the cloud-management facility. As discussed in preceding subsections, the cloud-management facility 2304 provides an administration interface 2324 that allows system administrators and system managers to administer the infrastructure of the private data center. This administration interface is enhanced to allow system administrators to initiate allocation of remote infrastructure as a remote private data center on the remote cloud-computing facility, including setting the values of various parameters that characterize the maximum amount of remote infrastructure that can be allocated, maximum cost that can be incurred, and other such parameters. The enhanced administration interface also allows system administrators to specify policies, conditions, and constraints that control automated movement of virtual machines back and forth between the private data center and remote private data center.

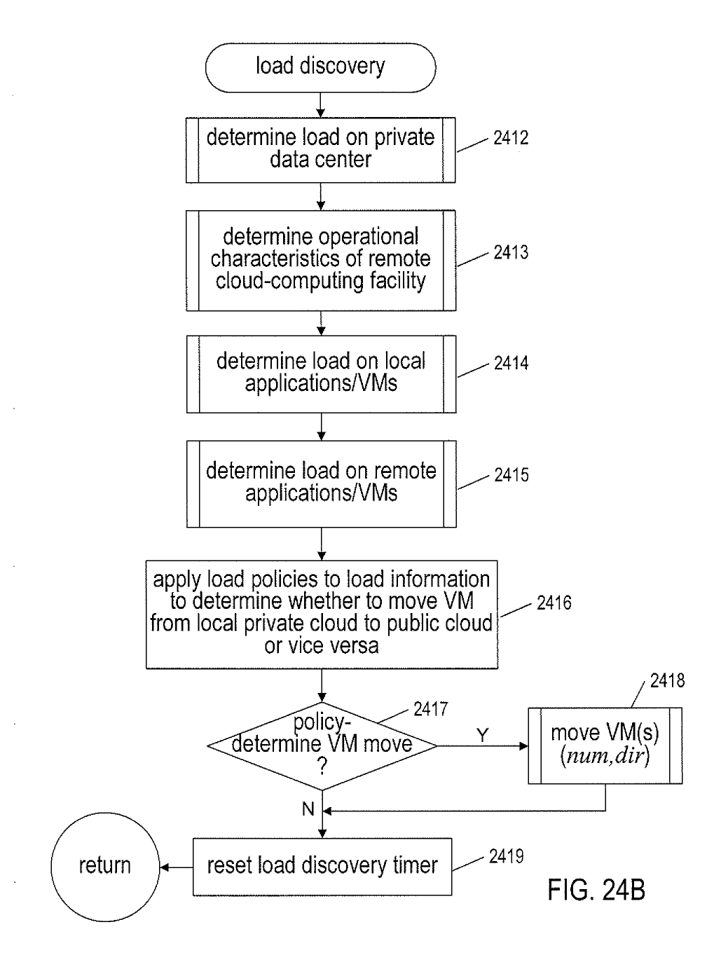

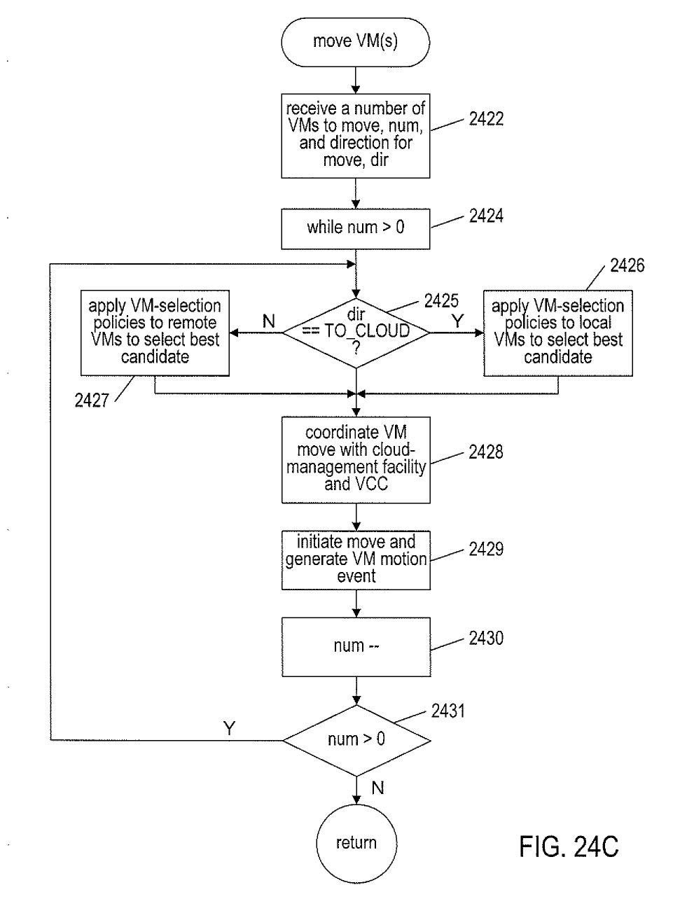

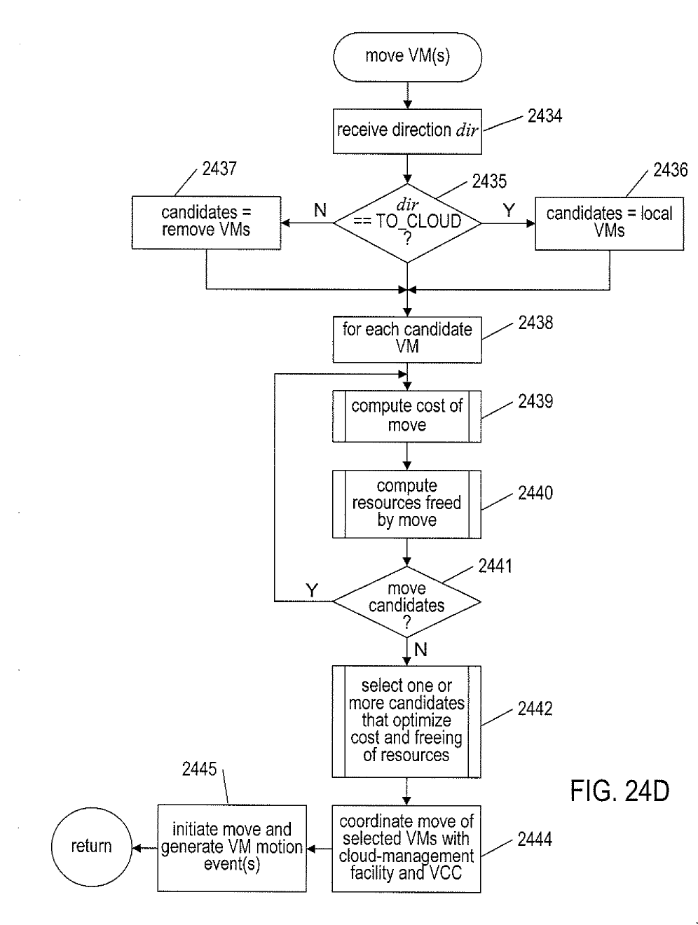

FIGS. 24A-D provide control-flow diagrams that illustrate one implementation of the local cloud-management-facility agent discussed above with reference to FIG. 23B. As shown in FIG. 24A, the local agent can be considered to continuously wait for and handle events that occur over time, in a continuous event-handling loop. In step 2402, the local agent waits for a next event to occur. When the next-occurring event is a load-discovery-timer expiration, as determined in step 2403, then a load-discovery handler is called in step 2404. Several variations of the load-discovery handler are discussed, below. Otherwise, when the event is a policy-update event, as determined in step 2405, then an update-policies handler is called in step 2406. Policy updating is dependent on the types of policy endowing and policy-application methods that are used in any particular implementation. In general, policies can be created, edited, and deleted. Policy-update events are generated by the administration interface. When the event is a VM-motion event, as determined in step 2407, then, in step 2408, a reporting routine is called to report motion of a VM to the cloud-management facility. These events are used to keep the cloud-management facility informed of all VM relocations, so that the cloud-management facility can track operation and send commands to the VMs, whether executing locally or within the remote cloud-computing facility. Ellipses 2409 indicate that many other types of events may be handled in any given local-agent implementation. A final default handler 2410 may handle rare and unexpected events. When there are more events queued for processing, as determined in step 2411, then control returns to step 2403. Otherwise, control returns to step 2402, where the local agent waits for a next event to occur.

FIG. 24B illustrates an implementation of the load-discovery handler, called in step 2404 of FIG. 24A. In step 2412, the load-discovery handler accesses a cloud-management-facility interface in order to obtain metrics and parameters that characterize the current load on the private data center. The load-discovery handler may, in addition, access other administration-and-management interfaces within the private data center to obtain the load information. Load information is discussed further, below. In step 2413, the load-discovery handler accesses the VCC within the remote cloud-computing facility to determine the operational characteristics of the remote cloud-computing facility. These may include, as one example, the cost per unit currently being charged for infrastructure provided as a service by the remote cloud-computing facility. Other examples include any constraints and limits currently being enforced on the amount of various types of infrastructure that can be allocated on behalf of remote clients and information with regard to latencies associated with VM provisioning and application deployment on the remote cloud-computing facility. In step 2414, the load-discovery handler determines the load on local applications and VMs within the private data center, again accessing a cloud-management-facility interface and other administration-and-management interfaces within the private data center. Similarly, in step 2415, the load-discovery handler determines load on the remote applications and VMs executing within the remote private data center allocated from infrastructure provided by the cloud-computing facility. In step 2416, the load-discovery handler applies load policies, discussed further below, to the load information in order to determine whether or not to move one or more VMs from the local private cloud to the remote cloud or from the remote cloud to the local private cloud. When, as a result of application of the load policies to the load information, movement of one or more VMs between the private data center and the remote cloud-computing facility is indicated, as determined in step 2417, then, in step 2418, a move-VMs routine is called to carry out movement of VMs between the private center and cloud-computing facility. In a first-described implementation, the move-VMs routine takes a number of VMs to move and a direction of movement as arguments. As discussed below, in other implementations, the move VMs routine takes only a single argument indicating the direction of movement. Additional implementations are, of course, possible. Finally, in step 2419, the load-discovery handler resets a load-discovery time to expire at a next point in time at which movement of VMs is to be considered.

FIG. 24C provides one implementation of the move-VMs routine called in step 2418 of FIG. 24B. In step 2422, the routine receives a number of VMs to move, num, and a direction for the move, dir. In the while-loop of steps 2424-2431, the routine continues to select a best candidate VM to move until the number of VMs to be moved, specified by the argument num, have been moved in the direction specified by the argument dir. In step 2425, the routine determines whether or not the VMs are to be moved from the private data center to the remote cloud-computing facility. If so, the routine applies VM-selection policies to local VMs executing within the private data center to select a best candidate VM to move, in step 2426. Otherwise, in step 2427, the routine applies a different set of VM-selection policies to the remote VMs executing within the remote cloud-computing facility to select a best candidate for movement. In step 2428, the routine coordinates movement of the selected VM both with the cloud-management facility within the private data center and with the VCC associated with the remote cloud-computing facility. In step 2429, the routine initiates movement of the candidate VM in the indicated direction in cooperation with the cloud-management facility and VCC, and, in certain implementations, generates a VM motion event once movement of the VM has succeeded. In step 2430, the local variable num is decremented. While num is greater than 0, as determined in step 2431, the while-loop carries out an additional iteration.

FIG. 24D illustrates an alternative version of the move-VMs routine called in step 2418 of FIG. 24B. In this implementation, the routine receives a single argument that indicates the direction of movement of the VM, in step 2434. When the direction indicates movement of one or more VMs from the private data center to the remote cloud-computing facility, as determined in step 2435, a set variable candidates is initiated to include the local VMs currently executing within the private data center in step 2436. Otherwise, in step 2437, set variable candidates is initiated to include the remote VMs executing within the remote private data center allocated from infrastructure provided by the remote cloud-computing facility. In the for-loop of steps 2438-2441, the cost of moving the VM and the computational resources freed by moving the VM are computed for each of the candidate VMs selected in either of steps 2436 or 2437. Based on these computed costs and freed resources, one or more VMs are selected from the candidate VMs that optimize VM movement, in step 2442. There are many different possible optimization methods that can be employed to select one or more VMs to move. As one example, in certain cases, it may be desirable to move a set of one or more VMs that will free up a sufficient number of resources on the private data center in order that the percentage of resources used in the private data center falls below a threshold value while, at the same time, minimizing the costs of VM movement, which may include high costs associated with moving VMs due to security constraints or communications constraints. In many cases, a generalized optimization procedure with policy-specified constraints may be employed to select VMs for movement. Once one or more VMs are selected for movement, the routine coordinates the move and initiates the move in steps 2444-2445, as in the previously discussed move-VMs routine shown in FIG. 24C. VM selection is generally controlled by policies and parameters, including threshold values, and may also include programmed optimization. In certain implementations, VM selection may be specified in a logic programming language, such as Prolog. In other cases, VM selection may involve application of various logic filters and operations.

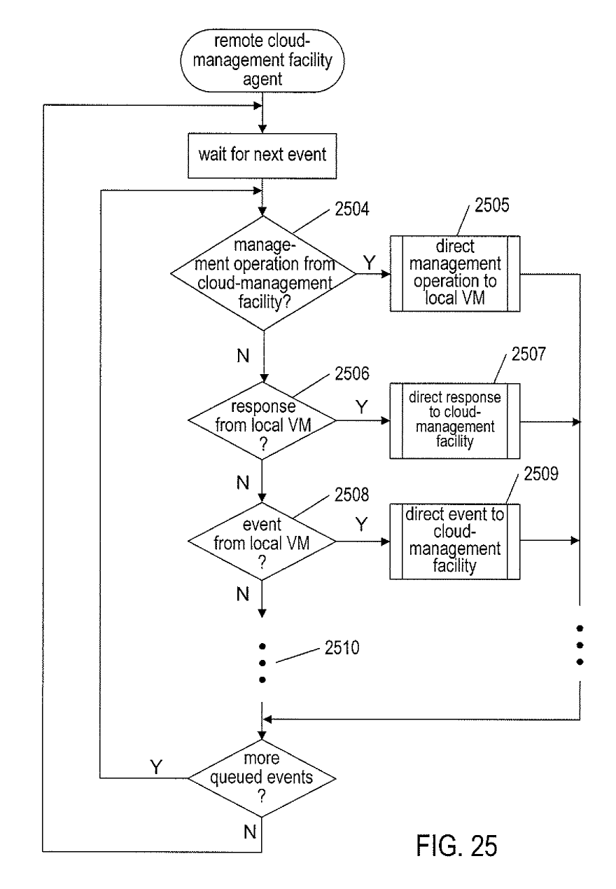

FIG. 25 provides a flow-control diagram that illustrates implementation of the remote cloud-management-facility agent discussed above with reference to FIG. 23B. The remote cloud-management-facility agent, like the local agent, continuously executes an event-handling loop to handle events that occur over time. These events include reception of management operations from the cloud-management facility, as detected in step 2504, messages received from the local VMs within the remote cloud-computing facility, as detected in step 2506, and events that arise from execution of the local VMs within the remote cloud-computing facility, as detected in step 2508. Ellipses 2510 indicate that various other types of events may handled by the remote cloud-management facility agent. In general, the remote cloud-management-facility agent acts as a communications relay to facilitate communications between the cloud-management facility within the private data center and remote VMs executing within the remote private data center allocated from infrastructure provided by the remote cloud-computing facility. Thus, management operations received from the cloud-management facility are directed to local VMs, in step 2505, responses from local VMs are directed to the cloud-management facility, in step 2507, and the events raised by execution of local VMs within the remote cloud-computing facility are directed to the cloud-management facility in step 2509.

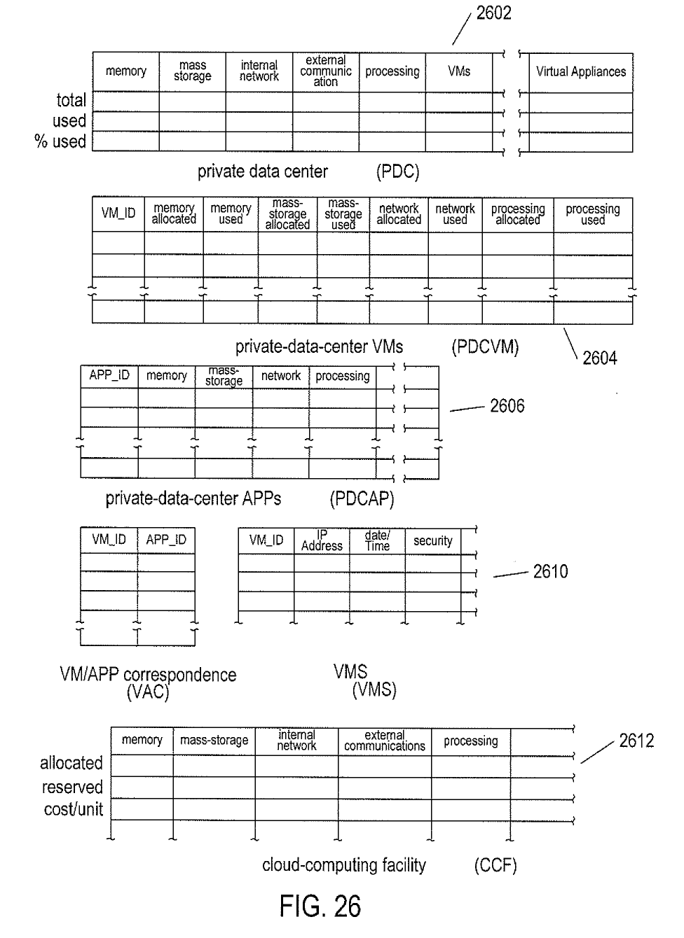

FIG. 26 illustrates the type of facility-load, VM-load, and application-load information that may be accessed and compiled by the load-management handler for subsequent application of load policies and candidate-VM-selection policies. This information is shown as compiled into tables, such as relational-database tables, but may be stored in any of many different types of in-memory data structures, depending on the implementation. Load on the private data center is characterized by information stored in the private-data-center table (“PDC table”) 2602. Columns of the table represent the total memory, mass-storage, internal network, external communications, and processing resources of the private data center, as well as a number of VMs and virtual appliances that can be supported by the private data center. Rows correspond to total amount of the resources, the amount of resources currently used, and the percentage of the resources currently used. Of course, many other types of information may be additionally compiled in order to characterize private-data-center load, including error logs, recorded provision-request denials, performance data, and many other types of information that may be maintained within the private data center. A private-data-center-VMs table (“PDCVM table”) 2604 stores information about each of the currently provisioned and executing VMs on the private data center. This information includes an identifier for each VM as well as indications of the amount of various computational resources allocated to, and used by, the VM. Similarly, information about the computational resources allocated to, or used by, applications running in VMs on the private data center are stored in a private-data-center-APPs table (“PDCAP table”) 2606. A VM/APP correspondence table 2608 stores correspondences between VM identifiers and application identifiers and a VMs table 2610 stores information about currently provisioned and executing virtual machines within the private data center. A cloud-computing facility table (“CCF table”) 2612 stores information that characterizes computational resources provided by the remote cloud-computing facility. This information may include the amount of the resources allocated and reserved on behalf of the private data center as well as a cost per unit for the resources. Note that information about the VMs executing on the private data center may include one or more IP addresses for the VM, a date and time of creation, and an indication of the security level of the VM with respect to motion, with high values indicating that the VM has relatively onerous security requirements that would inhibit movement of the VM to the remote cloud-computing facility under all but the most extreme cases.

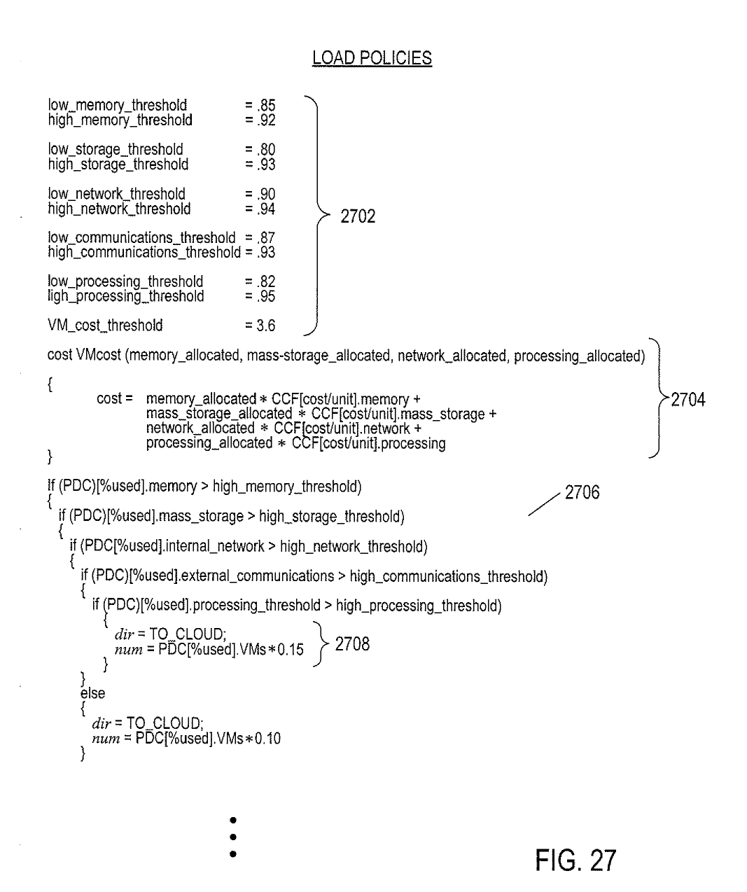

FIG. 27 indicates the nature of load policies that may be specified, maintained, and applied by the load-discovery handler discussed above with reference to FIGS. 24A-B. There are many different ways that load policies may be specified and encoded. In the example shown in FIG. 27, load policies may be specified programmatically using defined constant values, such as threshold values 2702, functions, such as a cost function 2704 that computes a cost associated with a currently executing VM, and complex policy statements, with FIG. 27 showing a portion of a programmed complex policy statement 2706. In this example, when the amount of the various computational resources of the private data center currently used exceed high threshold values, the variables dir and num are given values 2708 to indicate relocation of 15 percent of the current VMs within the private data center to the remote cloud by a move-VMs routine such as that shown in FIG. 24C. Of course, many different types of policies and policy encodings can be used. The policies and policy encodings are developed through an administrative user interface provided by the cloud-management facility to system administrators and managers. By developing policies and providing values for various parameters and constraints, system administrators and managers can configure the private data center and cloud-management facility to automatically move VMs back and forth between the private data center and the remote cloud-computing facility in order to handle high computational loads in as cost-effective a manner as possible. In certain cases, for example, system administrators may choose to offload VMs to the remote cloud-computing facility in order to maintain relatively large percentages of computational resources available within the private data center, because the instantaneous load on the private data center may be quite variable and difficult to predict while, at the same time, the latency for handling the variable load is critical. In other cases, system administrators may choose to offload VMs only when the computational resources of the private data center are taxed nearly to their limit. Many different types of considerations may constrain and shape the load policies and policies that control selection of VMs for offloading to the remote cloud-computing facility, including cost of executing VMs in the remote cloud-computing facility, costs of moving VMs from the private data center to the remote cloud-computing facility, increasing communications overheads that may result from movement of VMs, security concerns associated with VMs, and other such factors.

Although the present invention has been described in terms of particular embodiments, it is not intended that the invention be limited to these embodiments. Modifications within the spirit of the invention will be apparent to those skilled in the art. For example, any of many different implementations may be obtained by varying any of many different design and implementation parameters, including the hardware and cloud-computing platforms, programming languages, modular organization, control structures, data structures, and other such design and implementation parameters. As discussed above, the load policies and candidate-VM-selection policies may be encoded in various different ways in order to specify and constrain automated movement of VMs between the private data center and the remote cloud-computing facility.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. An extended cloud-management facility comprising:
a private data center having multiple servers, one or more internal communications networks, multiple mass-storage devices, and a cloud-management facility that manages the private data center and provides an administration-and-management interface through which management and administration operations and functionalities are accessed;
a remote cloud-computing facility having multiple servers, one or more internal communications networks, multiple mass-storage devices, and an interface through which cloud-computing-facility infrastructure and resources are accessed and virtual machines are moved;
cloud-management-facility load-discovery and virtual-machine-selection components within the private data center that control automated movement of virtual-machines and applications between the private data center and remote cloud-computing facility;
a remote cloud-management-facility agent within the remote cloud-computing facility, and
a secure communications connection through which the cloud-management facility communicates with the remote cloud-management-facility agent in order to manage virtual machines moved from the private data center to the remote cloud-computing facility by the cloud-management-facility load-discovery and virtual-machine-selection components.

2. The extended cloud-management facility of claim 1 wherein the administration-and-management interface provided by the cloud-management facility includes input features that control the cloud-management facility to contract for remote computational infrastructure provided by the remote cloud-computing facility.

3. The extended cloud-management facility of claim 1 wherein the load-discovery component periodically determines the computational loads on the private data center, virtual machines and applications executing locally within the private data center, and virtual machines and applications executing remotely within the remote cloud-computing facility.

4. The extended cloud-management facility of claim 3 wherein the computational load on the private data center includes indications of the total amount of computational resources and the amount of computational resources allocated to currently executing virtual machines and virtual appliances.

5. The extended cloud-management facility of claim 1 wherein 4 wherein the computational resources include:
memory,
mass-storage;
internal networking;
external communications bandwidth; and
processor bandwidth.

6. The extended cloud-management facility of claim 3 wherein, after determining the computational loads, the load-discovery component applies load policies to the determined computational load or the private data center in order to determine whether or not to move one or more virtual machines from the private data center to the remote cloud-computing facility or from the remote cloud-computing facility to the private data center.

7. The extended cloud-management facility of claim 6 wherein the load polices are specified through the administration-and-management interface.

8. The extended cloud-management facility of claim 7 wherein the load policies include thresholds and logic statements that determine whether computational loading on private data center is sufficient to justify moving one or more virtual machines to the remote cloud-computing facility.

9. The extended cloud-management facility of claim 7 wherein the load policies include thresholds and logic statements that determine whether computational loading on private data center is sufficiently low to justify moving one or more virtual machines back from the remote cloud-computing facility to the private data center.

10. The extended cloud-management facility of claim 6 wherein, when the load-discovery components determines that one or more virtual machines are to be moved from the private data center to the remote cloud-computing facility, the load-discovery module invokes the virtual-machine-selection component to select one or more virtual machines from the virtual machines currently executing within the private data center for relocation.

11. The extended cloud-management facility of claim 1 wherein the virtual-machine-selection component uses the determined virtual machine loads and application loads, threshold values, and logic statements to identify one or more virtual machines, relocation of which satisfies one or more relocation goals, constraints, and considerations.

12. The extended cloud-management facility of claim 11 wherein the relocation goals include freeing sufficient computational resources within the private data center so that the computational resources available for allocating to newly provisioned virtual machines rises above a threshold level.

13. The extended cloud-management facility of claim 11 wherein the relocation goals include minimizing the cost associated with executing the virtual machines currently provisioned and anticipated to be provisioned by the cloud-computing facility.

14. The extended cloud-management facility of claim 11 wherein relocation goals include minimizing latencies and delays associated with virtual-machine movement between the private data center and the remote cloud-computing facility.

15. The extended cloud-management facility of claim 11 wherein the relocation constraints include avoiding relocating virtual machines associated with security concerns from the private data center to the remote cloud-computing facility.

16. The extended cloud-management facility of claim 11 wherein the relocation considerations include the available computational resources on the private data center, the available computational resources on the remote cloud-computing facility, and changes in computational resources needed by virtual machines when the virtual machines are relocated.

17. A method that expands and contracts the computational resources of a private data center having multiple servers, one or more internal communications networks, multiple mass-storage devices, and a cloud-management facility that manages the private data center and provides an administration-and-management interface through which management and administration operations and functionalities are accessed, the method comprising:
contracting, through the administration-and-management interface, for remote computational resources provided by a remote cloud-computing facility having multiple servers, one or more internal communications networks, multiple mass-storage devices, and an interface through which cloud-computing-facility infrastructure and resources are accessed and virtual machines are moved;
periodically monitoring, by a cloud-management-facility load-discovery component, the computational load on the private data center and applying load policies to indications of the current computational load on the private data center; and
when application of the load policies to indications of the current computational load on the private data center indicate that one or more virtual machines should be relocated to the remote cloud-computing facility to execute using the contracted for remote computational resources,
selecting one or more virtual machines for relocation by a cloud-management-facility virtual-machine-selection component, and
moving the selected one or more virtual machines through the interface of the remote cloud computing facility through which virtual machines are moved.

18. The method of claim 17 wherein, following relocation of the one or more selected virtual machines to the remote cloud-computing facility, the cloud-management facility communicates with the relocated virtual machines via a secure communications connection established between the cloud-management facility and a remote cloud-management-facility agent within the remote cloud-computing facility.

19. The method of claim 18 wherein the load polices are specified through the administration-and-management interface and wherein the load policies comprise threshold values, and logic statements.

20. A physical data-storage device that stores computer instructions that, when executed by one or more physical processors within a private data center having multiple servers, one or more internal communications networks, multiple mass-storage devices, and a cloud-management facility that manages the private data center and provides an administration-and-management interface through which management and administration operations and functionalities are accessed, control the private data center to
contract, through the administration-and-management interface, for remote computational resources provided by a remote cloud-computing facility having multiple servers, one or more internal communications networks, multiple mass-storage devices, and an interface through which cloud-computing-facility infrastructure and resources are accessed and virtual machines are moved;
periodically monitor, by a cloud-management-facility load-discovery component, the computational load on the private data center and applying load policies to indications of the current computational load on the private data center; and
when application of the load policies to indications of the current computational load on the private data center indicate that one or more virtual machines should be relocated to the remote cloud-computing facility to execute using the contracted for remote computational resources,
select one or more virtual machines for relocation by a cloud-management-facility virtual-machine-selection component, and
move the selected one or more virtual machines through the interface of the remote cloud computing facility through which virtual machines are moved.
